(19) United States
(12) Patent Application Publication
(10) Pub. No.: US 2008/0293154 A1
(43) Pub. Date: Nov. 27, 2008

(54) Apparatus and method for detecting target

(75) Inventor: Masao Makiuchi, Kawasaki (JP)

Correspondence Address: KRATZ, QUINTOS & HANSON, LLP, 1420 K Street, N.W., Suite 400, WASHINGTON, DC, 20005, US

(73) Assignee: FUJITSU LIMITED, Kawasaki (JP)

(21) Appl. No.: 12/071,634

(22) Filed: Feb. 25, 2008

(30) Foreign Application Priority Data
Feb. 26, 2007 (JP) 2007-045790
Aug. 29, 2007 (JP) 2007-222638

(51) Int. Cl. G01N 21/64

(52) U.S. Cl. 436/172; 422/82.08

(57) ABSTRACT

The target detecting apparatus includes: a first container having a metal inside and containing a fluorescent particle which generates fluorescence on exposure to light and quenches the fluorescence on contacting the metal; a second container having the metal inside and containing a target sample that contains at least the fluorescent particle therein; a centrifugal force giving unit configured to allow the fluorescent particles to be in contact with the metal by giving a centrifugal force to the first container and the second container; a light irradiation unit configured to expose the fluorescent particle contained in each of the first container and the second container to light; and a fluorescence detecting unit configured to detect an intensity of fluorescence generated by the fluorescent particle upon exposure to light from the light irradiation unit.

### CROSS-REFERENCE TO RELATED APPLICATIONS

This application is based upon and claims the benefits of the priority from the prior Japanese Patent Application Nos. 2007-045790 filed on Feb. 26, 2007 and 2007-222638 filed on Aug. 29, 2007, the entire contents of which are incorporated herein by reference.

### BACKGROUND OF THE INVENTION

1. Field of the Invention

The present invention relates to an apparatus and method for detecting targets, which apparatus and method are capable of detecting targets in a short time efficiently by detecting fluorescent particles that produce fluorescence upon exposure to light, such as fine particles of various targets (for example, proteins and antigens) labeled with a fluorescent label and of capturers labeled with a fluorescent label (for example, antibodies) capable of combining with the targets.

2. Description of the Related Art

Detection of fluorescence from fine particles of a fluorescent-labeled sample conventionally involves irradiation of excitation light and subsequent detection of fluorescence intensity from them, and measurement instruments required for biotechnology-related purposes, such as fluorescence microscopes and fluorescent image scanners for DNA micro-array, have been put into practice. For protein detection, techniques have been established in which an antigen or antibody is previously modified with a fluorescent label, and only the fluorescence generated by the complex formed by reaction of the antigen with antibody is detected to identify the nature of the antigen or antibody.

Examples of these techniques include an ELISA method, in which either an antigen or an antibody is immobilized onto a base or side surface of a container, and the other (antibody in the case where the antigen has been immobilized to the container, or antigen in the case where the antibody has been immobilized to the container) is allowed to combine with the immobilized antigen (or antibody). This method has had such a problem that since the binding partners diffuse through the solution to reach the base surface or side surface of the container, it takes several hours for them to move by a distance of about 1.5 mm, and accordingly it is often the case that it takes over 1 day before obtaining the measurement results. And in a practical measurement using ELISA method, a large quantity of sample for the measurement is required. However, since the sample is frequently a blood collected from the body or a trace amount of substance contained in the body fluid, it is preferable to reduce the amount of sample used. Studies have been conducted on protein sensing systems using the ELISA method for detection (refer to Cho Seung-jin, et al., “Investigation of the Fundamental-Measuring Techniques for Protein Sensing System”, SHARP GIHO, August 2006, Vol. 94) and there is an demand for further development of a detection technology that enables measurement results to be obtained more readily, shortly and with small sample amount.

An object of the present invention is to overcome the problem in the related art and to achieve the following objective. More specifically, it is an object of the present invention to provide an apparatus and method for detecting targets, which apparatus and method are capable of detecting targets in a short time efficiently by detecting fluorescent particles that produce fluorescence upon exposure to light, such as fine particles of various targets (for example, proteins and antigens) labeled with a fluorescent label and of capturers labeled with a fluorescent label (for example, antibodies) capable of combining with the targets.

### BRIEF SUMMARY OF THE INVENTION

According to an aspect of an embodiment, there is the target detecting apparatus which includes at least a first container having metal inside and containing in it a fluorescent particle which generates fluorescence on exposure to light and quenches it on contacting with the metal, a second container having metal inside and containing in it the sample of target at least containing the fluorescent particle, an unit giving a centrifugal force to put the fluorescent particle in contact with the metal by giving a centrifugal force to the first container and the second container, an unit to expose the fluorescent particle contained in each of the first container and the second container to light, and an unit to detect an intensity of fluorescence generated by the fluorescent particle on exposure to light from the light irradiation unit.

According to an aspect of an embodiment, there is the target detecting method which includes a step for giving a centrifugal force, in which a centrifugal force is given to the first container having metal inside and containing in it a fluorescent particle which generates fluorescence on exposure to light and quenches it on contacting the metal and to the second container having the metal inside and containing in it the sample of the target at least including the fluorescent particle, and the fluorescent particles are put in contact with the metal thereby, a step for exposing to light, in which the fluorescent particle contained in each of the first container and the second container is exposed to light, and a step for detecting fluorescence to determine the intensity of fluorescence generated by the fluorescent particle on exposure to light from the light irradiation unit.

### BRIEF DESCRIPTION OF THE SEVERAL VIEWS OF THE DRAWINGS

FIG. 1 is a schematic illustration for a description of the principle of centrifugation.

FIG. 2 is a graphical representation indicating the relationship between the sedimentation coefficient (S) and the sedimentation time (T) of the particles.

FIG. 3 is a graphical representation indicating the relationship between the sedimentation time (T) of the particles and the number of revolutions (N) of a centrifugal separator.

FIG. 4A is a photograph (Part 1) showing a phenomenon of light quenching of a fluorescent label caused by contact with the gold film.

FIG. 4B is a photograph (Part 2) showing a phenomenon of light quenching of a fluorescent label caused by contact with the gold film.

FIG. 4C is a photograph (Part 3) showing a phenomenon of light quenching of a fluorescent label caused by the contact with the gold film.

FIG. 5 is a graphical representation indicating the relationship between the time spans of fluorescence pulses and the number of revolutions of the centrifugal force giving unit.

FIG. 6 is a graphical model representation indicating an example of the relationship between the pulse intensity of the fluorescence of the fluorescent particles and the sedimentation time, when the number of revolutions of the centrifugal force giving unit is constant.

FIG. 7 is a graphical model representation indicating an example of the relationship between the fluorescence pulse intensity of the fluorescent particles and the number of revolutions, when the time required for the centrifugal force giving unit to raise the number of revolutions to the maximum is constant.

FIG. 8 is a schematic explanatory illustration showing embodiment 1 of the target detecting apparatus of the present invention.

FIG. 9A is a side view showing embodiment 2 of the target detecting apparatus of the present invention.

FIG. 9B is a top view showing embodiment 2 of the target detecting apparatus of the present invention.

FIG. 10A is a side view showing embodiment 3 of the target detecting apparatus of the present invention.

FIG. 10B is a top view showing embodiment 3 of the target detecting apparatus of the present invention.

FIG. 11 is a schematic explanatory illustration showing embodiment 4 of the target detecting apparatus of the present invention.

FIG. 12 is a graphical representation indicating an example of changes in the intensity of fluorescence with time for the fluorescent particles measured simultaneously for the four different samples using the target detecting apparatus of embodiment 4.

FIG. 13 is a schematic explanatory illustration showing embodiment 5 of the target detecting apparatus of the present invention.

FIG. 14 is a schematic explanatory illustration showing embodiment 6 of the target detecting apparatus of the present invention.

FIG. 15 is graphical representation indicating an example of the detection result of the fluorescence intensity of the fluorescent particles measured using the target detecting apparatus of embodiment 5 and 6.

FIG. 16A is a photograph (Part 1) showing the light quenching phenomenon of the fluorescent particle used in Example 1 caused by the contact with the gold film.

FIG. 16B is a photograph (Part 2) showing the light quenching phenomenon of the fluorescent particle used in Example 1 caused by the contact with the gold film.

FIG. 16C is a photograph (Part 3) showing the light quenching phenomenon of the fluorescent particle used in Example 1 caused by the contact with the gold film.

FIG. 16D is a photograph (Part 4) showing the light quenching phenomenon of the fluorescent particle used in Example 1 caused by the contact with the gold film.

FIG. 16E is a photograph (Part 5) showing the light quenching phenomenon of the fluorescent particle used in Example 1 caused by the contact with the gold film.

FIG. 17A is a photograph (Part 1) showing a change of fluorescence of the fluorescent particle used in Example 1 on a synthetic quartz substrate.

FIG. 17B is a photograph (Part 2) showing the fluorescence change of the fluorescent particle used in Example 1 on the synthetic quartz substrate.

FIG. 17C is a photograph (Part 3) showing the fluorescence change of the fluorescent particle used in Example 1 on the synthetic quartz substrate.

FIG. 17D is a photograph (Part 4) showing the fluorescence change of the fluorescent particle used in Example 1 on the synthetic quartz substrate.

FIG. 17E is a photograph (Part 5) showing the fluorescence change of the fluorescent particle used in Example 1 on the synthetic quartz substrate.

FIG. 18 is a graphical representation indicating a relationship between the time course (corresponds to the sedimentation time or the number of revolutions of the centrifugal unit) of the fluorescent particle used in Example 1 on the gold film and the synthetic quartz substrate and the intensity of fluorescence.

FIG. 19 is a graphical representation indicating the relationship between the sedimentation coefficient (S) of proteins and the sedimentation time (T).

FIG. 20 is a schematic explanatory illustration showing the target detecting apparatus used in Example 1.

FIG. 21 is a graphical representation indicating a result of detection of the fluorescent particles in Example 1.

FIG. 22 is a graphical representation indicating an example of the result of detection of fluorescence by the time-resolved fluorescence detecting method.

FIG. 23A is a top view showing embodiment 7 of the target detecting apparatus of the present invention.

FIG. 23B is a side view showing embodiment 7 of the target detecting apparatus of the present invention.

FIG. 24A is a schematic illustration (Part 1) for a description of the relationship among a distance (d) between the optical fibers, a rotation velocity (v), and a delay time (Td) in embodiment 7 of the target detecting apparatus of the present invention.

FIG. 24B is a schematic illustration (Part 2) for a description of the relationship among a distance (d) between optical fibers, a rotation velocity (v), and a delay time (Td) in embodiment 7 of the target detecting apparatus of the present invention.

FIG. 25 is a graphical representation showing an example of the change in the fluorescence intensity of a delayed fluorescence particle on the synthetic substrate and on the gold film.

FIG. 26 is a graphical representation showing a result of a comparison experiment among a fluorescent pigment and delayed fluorescence pigments in the change of the fluorescence intensity.

### DETAILED DESCRIPTION OF THE INVENTION

### (Apparatus and Method for Detecting Target)

The target detecting apparatus have at least a first container, a second container, a centrifugal force giving unit, a light irradiation unit, and a fluorescence detecting unit. Preferably, in addition to these units, the target detecting apparatus have a unit to control detection and a unit to evaluate the fluorescence intensity, and further additional units selected appropriately as occasion demands.

The target detecting method includes at least a centrifugal force giving step, a light irradiation step, and a fluorescence detecting step. Preferably, in addition to these steps, the target detecting method have a step for controlling detection and a step for evaluating the fluorescence intensity, and further additional steps selected appropriately as occasion demands.

The target detecting method can be so applied appropriately by using the target detecting apparatus that an act of operating the target detecting apparatus means an act of application of the target detecting method.

Through the following description of the target detecting apparatus, the detail of the target detecting method also is made clear.

### <First Container and Second Container>

The first container has metal inside and contains in it a fluorescent particle which generates fluorescence on exposure to light and quenches it on contacting the metal.

The second container has metal inside and contains in it the sample of target containing at least the fluorescent particles.

### —Metal—

The manner in which the metal is provided is not restricted particularly, and can be selected suitably according to the purpose. Preferably, however, the metal may be positioned on the base or on the base and the side inside the first container and the second container.

Kinds of the metal used are not restricted particularly, and can be selected suitably; however, gold is preferably used. Purities of gold used are not restricted, and can be selected suitably according to the purpose; however, the purity of the gold is preferably 99.9% or more.

When gold is used as the metal, it is preferred to be provided in the form of film. The methods for depositing gold in the form of film (or a gold film) are not restricted particularly, and can be selected suitably according to the purpose; for example, vacuum evaporation and plating are available.

The first and second containers are preferably provided on the centrifugal force giving unit; the number of the second containers is not restricted particularly, and can be selected suitably according to the purpose; however, a plurality of the second containers are preferably used. In this case, the samples of the targets contained in the plurality of the second containers can be measured simultaneously, and by which the efficiency of the measurement can be improved. And also in this case, the plurality of the containers is preferably configured along the circumference of rotation of the centrifuge.

The shape of the first and second containers container is not restricted, and can be selected suitably according to the purpose; the shape is a round shape and a rectangular shape, for example and the base of the containers is preferably flat.

The volume of the first and second containers is not restricted and can be selected suitably according to the purpose; however, in case the base has a round shape, it is preferably about 3 mm to 10 mm in diameter. An antibody and a complex of the antibody and antigen contained in these containers are in thermal motion and in a state of colliding and leaving from the gold film, the region in which they repeat collisions with the gold film is restricted to the close vicinity of the gold film. Therefore, by setting the size of the base to the range of values described above, the region in which the fine particles interact with the gold film can be enlarged.

In such a case, as to the sample amount, the sample is preferably loaded in the container to the depth of about 0.5 mm, for example. Also in such case, where the sample amount is scanty, these containers are preferably sealed with a transparent glass plate, etc., in order to inhibit the change of fluid volume due to evaporation, etc.

### —Fluorescent Particle—

The fluorescent particle is not restricted particularly, so far as it generates fluorescence on exposure to light and quench it on contacting the metal, can be selected suitably according to the purpose; preferred examples include, in addition to fluorescent labels themselves, targets labeled with the fluorescent labels, target capturers which are capable of capturing the targets and are labeled with the fluorescent label, and particles of complexes of the targets and the target capturers, which are labeled with the fluorescent labels.

When either any of the above targets or any of the above target capturers is to be labeled with the fluorescent label, among the two kinds of particles, the particle which is smaller in at least any of particle diameter and mass than the other is preferred to be modified with the fluorescent label, e.g., antibody is preferably labeled in the case where the target and target capturer are antigen and antibody, respectively.

Methods for the modification are not restricted particularly, and can be selected suitably from the related methods according to the purpose.

The fluorescent labels are not restricted particularly, can be selected suitably according to the purpose, and are preferably those which have a fluorescence peak wavelength (maximum excitation wavelength) from 500 nm to 900 nm. In such case and when the metal is gold, a conspicuous phenomenon arises, in which some energy shifts from the fluorescent label contacting with the gold to the gold and the fluorescence from the fluorescent label quenches. Examples of such fluorescent labels preferably include, for example, fluorescent pigments, and fluorescent complexes of rare earth elements.

The fluorescent pigments are not restricted particularly, can be selected suitably according to the purpose, and are preferably organic compound pigments, such as Cy3 (the excitation wavelength=515 nm, the peak wavelength of fluorescence=565 nm), for example.

The fluorescent complexes of rare earth elements are not restricted particularly, can be selected suitably according to the purpose, and are, for example, those described in “Special number: Rare earth element containing complex, Gekkan Materiaruinteguresyon, T.I.C., Inc., 2004, vol. 17 (3)”, more specifically preferably, DTBTA-Eu³⁺ (2,2′,2″,2′″-{4′-[(4,6-dichloro-1,3,5-triazin-2-yl)amino-biphenyl-4′″-yl]-2,2′:6′2′″-terpydine-6,6″diyl}bis(methyl-enenitrylo) tetraacetic acid; the excitation wavelength=325 nm, the peak fluorescence wavelength=616 nm), BHHCT-Eu³⁺ (the excitation wavelength=340 nm, the peak fluorescence wavelength=615 nm), BPTA-Tb³⁺ (the excitation wavelength=325 nm, the peak fluorescence wavelength=543 nm).

The fluorescent label may be used singularly or used in combination.

The fluorescent complexes of rare earth elements are also called as delayed fluorescence pigments, and the fluorescent particle modified with the delayed fluorescence pigment generates fluorescence on exposure to light, maintains it for a fixed time after the loss of the light, and quenches it on the contact with the metal. Therefore such a fluorescent particle is called as a delayed fluorescence particle.

Specifically, the delayed fluorescence pigment means a pigment that maintains fluorescence after the instantaneous loss of the excitation light and takes 1 ms or more before the fluorescence is quenched completely, and has a characteristic that it generates a fluorescence having a very long lifetime, a large Stokes shift (a difference between the maximum wavelength of the emission light and the maximum wavelength of the excitation light), and a narrow spectral line width. When complexes are formed with trivalent rare earth element ions, such as samarium (Sm³⁺), europium (Eu³⁺), terbium (Tb³⁺), and dysprosium (Dy³⁺), for example, they generate a strong fluorescence, maintain the fluorescence for 1 milliseconds or more after the instantaneous loss of the excitation light, and thus correspond to the delayed fluorescence pigments.

In contrast to these, the fluorescence generated by the organic compound pigment (for example, Cy3 (the excitation light wavelength=515 nm, the peak fluorescence wavelength=565 nm)), and a biological material, such as a protein and a nucleic acid, quenches in scores of micro seconds or less after the intercept of the excitation light, and thus has much shorter lifetime than the fluorescence generated by the delayed fluorescence pigments.

The targets are not restricted particularly, can be selected suitably according to the purpose, and are preferably organic molecules, for example.

Examples of the organic molecules include proteins, lipoproteins, glycoproteins, polypeptides, lipids, polysaccharides, lipopolysaccharides, nucleic acid, and drugs. Among these, proteins, plasma proteins, tumor markers, apoproteins, viruses, autoantibodies, clot/fibrinolysis factors, hormones, drugs in blood, HLA antigens, and nucleic acid are preferable, and proteins are more preferable.

Examples of the proteins include enzymes, such as avidin.

The target capturers are not restricted particularly, so far as they are capable of capturing the targets, and can be selected suitably according to the purpose.

The phrase “capable of capturing the target” means that the target capturer is capable of interacting with the target, and the aspects of the interaction are not restricted particularly and include adsorption, and chemical bonding (covalent bonding, ionic bonding, coordinate bonding, hydrogen bonding, and with an intermolecular force, etc.).

Specific examples of the target capturers include preferably antibodies, antigens, enzymes, and coenzymes against the targets. For example, when the target is an antigen, an antibody against the antigen can be selected as the target capturer, and when the target is an antibody, an antigen for the antibody can be selected as the target capturer. Furthermore, when the target is an enzyme (for example, avidin), a coenzyme for the enzyme (for example, biotin) can be selected as the target capturer, and when the target is a coenzyme (for example, biotin), an enzyme for the coenzyme (for example, avidin) can be selected as the target capturer.

The target sample containing at least the fluorescent particle is contained in the second container having metal inside. As described above, the fluorescence generated by the fluorescent particle quenches on the contact of the fluorescent particle with the metal. By detecting the intensity of the fluorescence generated by the fluorescent particles contained in the first and second containers, using the fluorescence detecting unit described later, various targets such as proteins can be detected.

The sample targets are not restricted particularly, so far as they contain the target to be detected; examples include pathogens such as bacteria and viruses, samples isolated from an organism, such as blood, saliva, and tissue lesion, and excreta such as excrement and urine. Furthermore, these samples may be concentrated to a sediment residue, directly or if necessary, by centrifugation, etc., and subsequently their cells may be disrupted, as a pretreatment, by treatment with enzyme, heat, surfactant, ultrasonic, or a combination thereof

### <Unit and Step for Giving Centrifugal Force>

The centrifugal force giving unit functions to contact the fluorescent particle with the metal by giving a centrifugal force to the first container and the second container.

The centrifugal force giving step is a step for contacting the fluorescent particle with the metal by giving a centrifugal force to the first container and the second container.

The centrifugal force giving step can be done appropriately by using the centrifugal force giving unit.

### —Centrifugal Force—

The centrifugal force giving units capable of giving the centrifugal force are not restricted particularly, so far as they are capable of accelerating centrifugally the fluorescent particles in the first container and in the second container, can be selected suitably according to the purpose, and include preferably the known centrifugal separator. The technique of centrifugation has been already established, is used for separating cells, etc., from suspension such as blood, and by using the centrifugal separator proteins can be isolated.

### [Principle of Centrifugation]

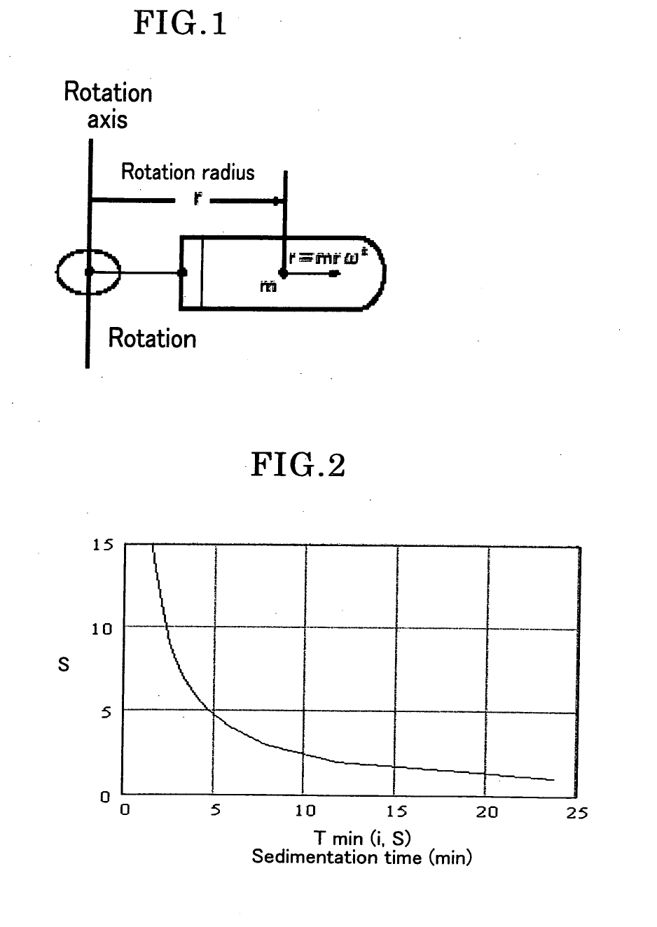

As shown in FIG. 1, when a particle having a mass, m, in a solution rotates with a rotation radius, r, and a rotation angular velocity ω, a centrifugal force as described in the following Equation (1) is exerted to the particle. As a result, the particle migrates to the base of the container (a centrifugation tube) containing the solution and the particle is separated from the solution.

f=mrω² Equation (1)
m: mass (g) of particle
r: rotation radius (cm)
ω: rotation angular velocity (rad/s)

The centrifugation is influenced by the diameter of the particle (d: cm), the density of the particle (σ: cm⁻³), the moving velocity of the particle (v: cm/sec), the density of the solution (ρ: g·cm⁻³), the viscosity of the solution (η: poise; g·cm⁻¹·s⁻¹), and the moving velocity, v, of the particle is called as sedimentation velocity and expressed in Equation (2).

v=S·rω²·10⁻¹³ Equation (2)

S=(d²/18)·((σ−ρ)/η)×10¹³ Equation (3)

wherein S expressed in the above Equation (3) is an indicator indicating the easiness with which the particle sediments (sedimentation coefficient) and is about 3 to 12 for a simple protein.

Sedimentation time T (s) during which the particle moves from the minimum rotation radius, Rₘᵢₙ, to the maximum rotation radius, Rₘₐₓ (where the particle is in contact with the base of the container) in the container (the centrifugation tube) containing the solution, is given by the following Equation (4).

T=[ln(Rₘₐₓ)−ln(Rₘᵢₙ)]×10¹³/(Sω²) Equation (4)

In FIG. 2, the sedimentation time in minute is shown, when S is varied from 0 to 15 and on condition that Rₘᵢₙ=10 cm, Rₘₐₓ=10.1 cm, and the number of revolutions N=80,000 rpm.

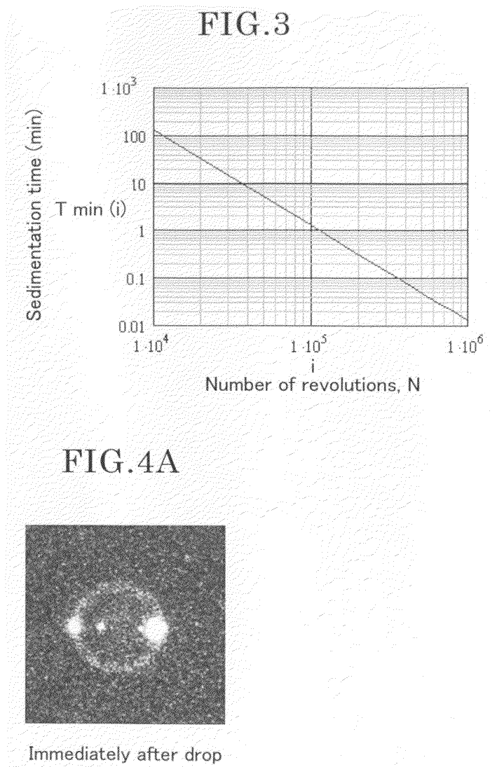

Furthermore, FIG. 3 shows a relationship between the sedimentation time T and the number of revolutions N, on condition that S=12, Rₘᵢₙ=10 cm, and Rₘₐₓ=10.1 cm.

When a protein is simple, S is from 3 to 12, and S becomes larger as a protein becomes more complex. As a protein becomes more complex, the sedimentation time T becomes shorter as seen in FIG. 2 and the number of revolutions N required for the separation becomes small as seen in FIG. 3. Such a centrifugal separator is widely used, since it is possible to set, widely and easily, the amount of the solution for measurement in the container (centrifugation tube) and the number of revolutions, etc.

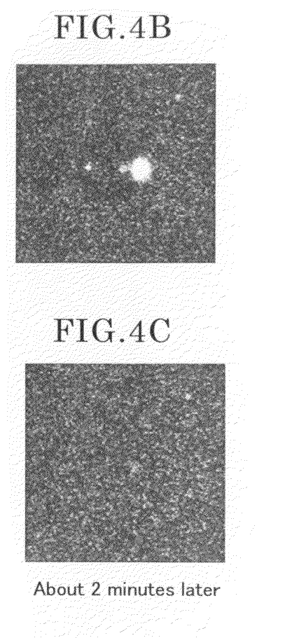

At this point, photographs are shown in FIG. 4A to FIG. 4C, in which the fluorescence generated immediately after the drop of 0.3 μL of 1×10⁻⁸M solution of the fluorescent label onto the gold film and a series of fluorescence until the fluorescent label solution dries after several minutes and the fluorescence is quenched by the contact of the fluorescent label with the gold film, are shown. These photographs were taken using a laser light, as an excitation light, with which a spot of the fluorescent label was irradiated obliquely from the upper left by means of an optical fiber, and an ICCD camera. In FIG. 4A showing fluorescence immediately after the drop of the fluorescent label, the fluorescent label is seen to emit fluorescence, in contrast to this, in FIG. 4B fluorescence is seen to degenerate in its intensity, and in FIG. 4C showing the state about 2 minutes after the drop, the fluorescence is seen to be quenched.

In contrast to the above case, in the case where a synthetic quartz substrate was used instead of the gold film, when a solution of the fluorescent label was dropped onto the synthetic quartz substrate, the fluorescence did not quenched and was observed steadily even several minutes or more after the drop.

Further, the phenomenon in which the fluorescent label quenches the fluorescence on the contact with the gold film has been confirmed to arise not due to fading of the fluorescent pigment.

Furthermore, even when the sample (solution) containing the fluorescent particle is not dried, the solution of only the fluorescent label and the solution of the target (streptavidin (SA)) labeled with the fluorescent label, are confirmed to quench the fluorescence on the contact with the gold film and confirmed to emit the fluorescence on the detachment from the gold film. In this phenomenon, when the gold film is formed inside the container and when the sample (solution) of the fluorescent particle (such as, the protein labeled with the fluorescent label) is contained in the container, the intensity of fluorescence decreases since the fluorescent particle contacts with the gold film. Therefore by using this phenomenon, fine particles (such as a complex formed from antigen-antibody reactions) can be detected using a relationship between the decreasing rate of the fluorescent intensity, and the sedimentation time of the fluorescent particle, the number of revolutions of the centrifugal unit and the centrifugal force. Although the centrifugal separators put into practice are used for separation and purification of particles, in the present usage, they are used to improve the frequency at which the fluorescent particles collide to the gold film formed on the base. This means that the above mentioned particles need not to be separated by the centrifugation for the purpose of the present invention.

For example, solution A containing an antibody (the target capturer) labeled with the fluorescent label beforehand, and solution B containing the labeled antibody and the antigen (the target), are put in equal amounts to each of the two containers (centrifugation tubes), and a centrifugal force is given to these containers by the centrifugal force giving unit. When the centrifugation tube comes to a certain position in the rotation circumference, the fluorescent label in the tube is excited by exposure to light from the light irradiation unit, and the fluorescence generated by the fluorescent label is detected by the fluorescence detecting unit. In this system, a fluorescence pulse is detected for each rotation. And, as the particle labeled with the fluorescent label sediments, the frequency at which the particle contacts with the gold film in the centrifugation tube increases and the fluorescence intensity decreases. This change in intensity of the fluorescence is detected by the fluorescence detecting unit. The sedimentation time (the frequency with which the particle collide to the gold film) of the solution B, when a complex is produced by antigen-antibody reaction in the solution B, is different from that of the solution A (is shorter than that of solution A (since the collision frequency to the gold film increases in solution B)). From this difference, it is possible to determine the formation of complexes by the antigen-antibody reaction.

### <Unit and Step for Light Irradiation>

The light irradiation unit functions to expose the fluorescent particles contained in each of the first container and the second container, to light.

The light irradiation step is for exposing the fluorescent particles contained in each of the first container and the second container, to light.

The light irradiation step can be conducted appropriately by the light irradiation unit.

The light irradiation units are not restricted particularly, so far as they can expose the sample to light, and can be selected suitably according to the purpose. The light is preferably an excitation light capable of exciting the fluorescent particle, and examples of the light irradiation unit include preferably LEDs, lamps, semiconductor lasers. Among these examples, semiconductor lasers are more preferable, for their excellence in monochromaticity and in irradiation efficiency.

The wavelengths of light emitted by the light irradiation unit are not restricted particularly, so far as they are absorbable by the fluorescent particle (the fluorescent label) and can make the fluorescent particle generate the fluorescence after its absorption, and can be selected suitably in relation to the excitation wavelength of the fluorescent particle.

Light emitted by the light irradiation unit is preferably a continuous light when the organic compound pigments are used as the fluorescent labels, and preferably a non-continuous light emitted at regular time intervals when the delayed fluorescence pigments are used as the fluorescent labels. When the delayed fluorescence pigment is exposed to the non-continuum light, by detecting the fluorescence from the delayed fluorescence pigment during the period from a certain time after the finish of exposure to light to the start of the next exposure, only the fluorescence from the delayed fluorescence pigment can be detected without the detection of the fluorescence from the impurities existing in the target sample (fluorescent substances which quench fluorescence immediately after the exposure to light) and the detection of the fluorescence intensity with less background noise and high sensitivity can be done.

Interval durations after the finish of exposure to light in case of the non-continuous light are not restricted particularly, can be selected suitably according to the purpose, and are preferably the durations longer than the lifetime of the fluorescence of the organic compound pigment and shorter than the fluorescence lifetime of the delayed fluorescence pigment, and are preferably 0.5 ms to 1 ms, for example.

Methods for adjusting the duration of interval are not restricted particularly, may be an method, in which the duration is adjusted to a certain exposure interval by pulsing the light, and may be a method, in which while using a continuous light, by changing the number of revolutions of the centrifugal force giving unit, the duration of interval between the exposure to light of the first container and the second container is adjusted. The latter case is advantageous because the detecting apparatus can be simplified and miniaturized.

### <Unit and Step for Detecting Fluorescence>

The fluorescence detecting unit functions to detect the intensity of fluorescence generated from the fluorescent particle exposed to light from the light irradiation unit.

The fluorescence detecting step is a step for detecting the intensity of fluorescence generated from the fluorescent particle exposed to light from the light irradiation unit.

The fluorescence detecting step can be conducted appropriately by using the fluorescence detecting unit.

The fluorescence detecting units are not restricted particularly, so far as they can detect fluorescence generated by the fluorescent particle exposed to light from the light irradiation unit, can be selected suitably according to the purpose, and are preferably a photodetector with high response speed, and include preferably a photomultiplier tube, an avalanche photodiode (APD), and a CCD camera. These may be used singularly or in combination.

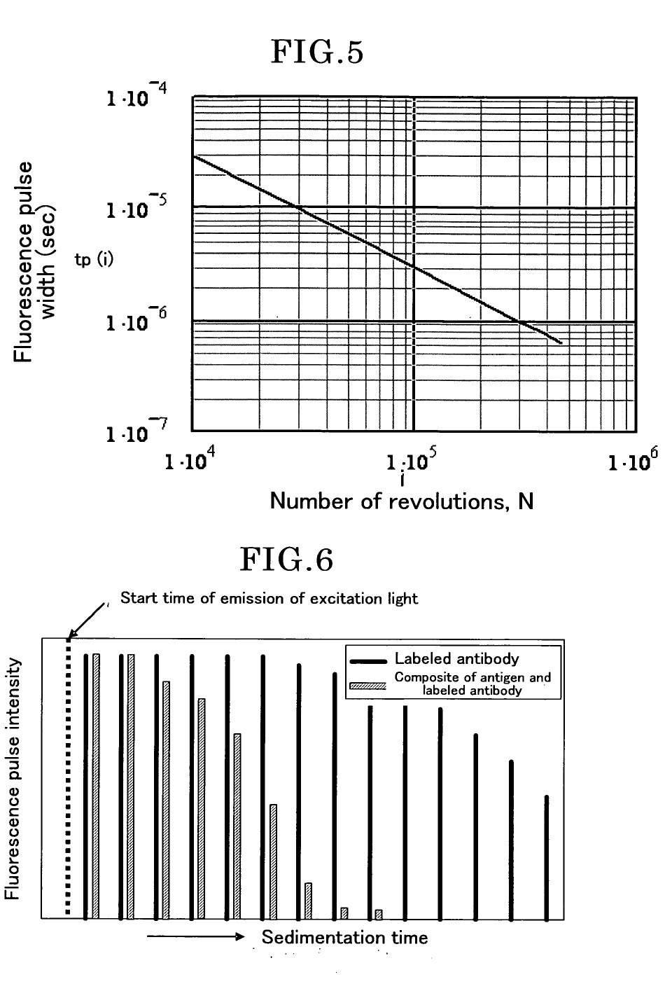

The relationship between the time span of the fluorescence pulse, obtained when the first container (or the second container, sometimes referred to, simply, as “container” below) has an internal diameter of 0.3 cm, and the number of revolutions of the centrifugal force giving unit, is shown in FIG. 5. The time spans of the fluorescence pulse are seen as about several microseconds to several tens of microseconds. Such a degree of pulse span is sufficient for the photomultiplier tube or the APD to detect the fluorescence. Further, the pulse span of the fluorescence can be varied suitably, by changing not only the number of revolutions, but also the diameter of the container. Specifically, in FIG. 5, in order to reduce the amount of sample solution containing the fluorescent particle, the internal diameter of 0.3 cm and the depth of the solution contained of 0.1 cm were set for the container.

The fluorescence intensity detecting steps are not restricted particularly, and can be selected suitably according to the purpose. And they include preferably, for example; a step (1) for detecting a relationship between the fluorescence intensity and the sedimentation time of the fluorescent particle, when the number of revolutions of the centrifugal separator is set to a constant value in the centrifugal force giving (centrifugation) step by the centrifugal force giving unit (centrifugal separator); a step (2) for detecting a relationship between the fluorescence intensity and the number of revolutions, when the time required for the number of revolutions to reach the maximum is set at a constant value.

In FIG. 6, an example of a relationship between the fluorescence intensity (the intensity of fluorescence pulse) of the fluorescent particle and the sedimentation time, using the step (1) in which the number of revolutions of the centrifugal force giving unit is set at a constant value, is illustrated as a model.

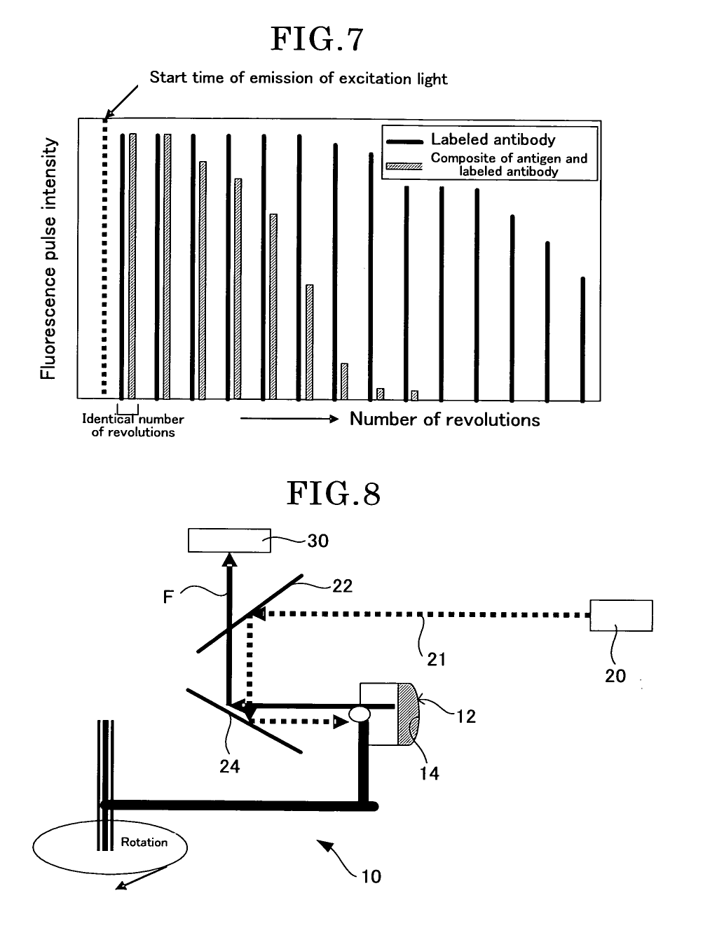

In FIG. 7, an example of a relationship between the fluorescence intensity (the fluorescence pulse intensity) and the number of revolutions, using the step (2) in which the time required for the number of revolutions to reach the maximum is set at a constant value, is illustrated as a model.

In FIGS. 6 and 7, the first container (the first centrifugation tube) and the second container (the second centrifugation tube) are set, and the first centrifugation tube that contained solution A having the fluorescent particle (labeled antibody) formed from an antibody by a modification with the fluorescent label is compared with the second centrifugation tube that contained solution (target sample) B in which a complex may be formed from the labeled antibody and the antigen, and the occurrence of the formation of the complex by an antigen-antibody reaction is determined by the difference in the sedimentation time or in the number of revolutions, of the labeled antibody between the first and second centrifugation tubes. When the complex is formed, since the mass of the complex in the second centrifugation tube is larger than that of the labeled antibody in the first centrifugation tube, the larger centrifugal force is given to the complex (the complex becomes easier to contact with the metal), and the reducing rate of the fluorescence pulse intensity becomes faster in the second centrifugation tube. On the other hand, when the complex is not formed from the labeled antibody and the antigen in the second centrifugal tube, the result of the rates of the fluorescence pulse intensity of the solution B is almost equal to that of the solution A containing only the labeled antibody, if it were illustrated in FIG. 6 and in FIG. 7.

### <Unit and Step for Controlling Detection>

The detection controlling unit functions to control the fluorescence detecting unit so that an intensity of the fluorescence generated by the delayed fluorescence particle is detected a certain time after the finish of the exposure to light from the light irradiation unit.

The detection controlling step is a step for so controlling the fluorescence detecting step that an intensity of the fluorescence generated by the delayed fluorescence particle is detected a certain time after the finish of the exposure to light from the light irradiation step.

The detection controlling step can be conducted appropriately by the detection controlling unit.

When the target sample containing at least a particle labeled with the fluorescent pigment as the fluorescent label is exposed to light from the light irradiation unit, background fluorescence may be generated from a substance other than the fluorescent pigment, which has a wavelength close to that of the fluorescent pigment, thereby reducing the detection sensitivity.

In particular, in the detection of a protein, background fluorescence from the impurities is considered to impair the detection sensitivity. In order to solve this problem, a method is preferably used, in which the object to be measured is labeled with the delayed fluorescence pigment which generates fluorescence over several milliseconds once excited, and the light from the light irradiation unit is pulsed, and only the delayed fluorescence is measured by the fluorescence detecting unit after the loss of the pulse light.

In this case, since almost all the fluorescence from the impurities quenches in a delay time of several microseconds or less, after the loss of the pulse light, only the fluorescence from the delayed fluorescence pigment may be detected in principle. Such a fluorescence detecting method is known as a time-resolved fluorescence detecting method.

### [Time-Resolved Fluorescence Detecting Method]

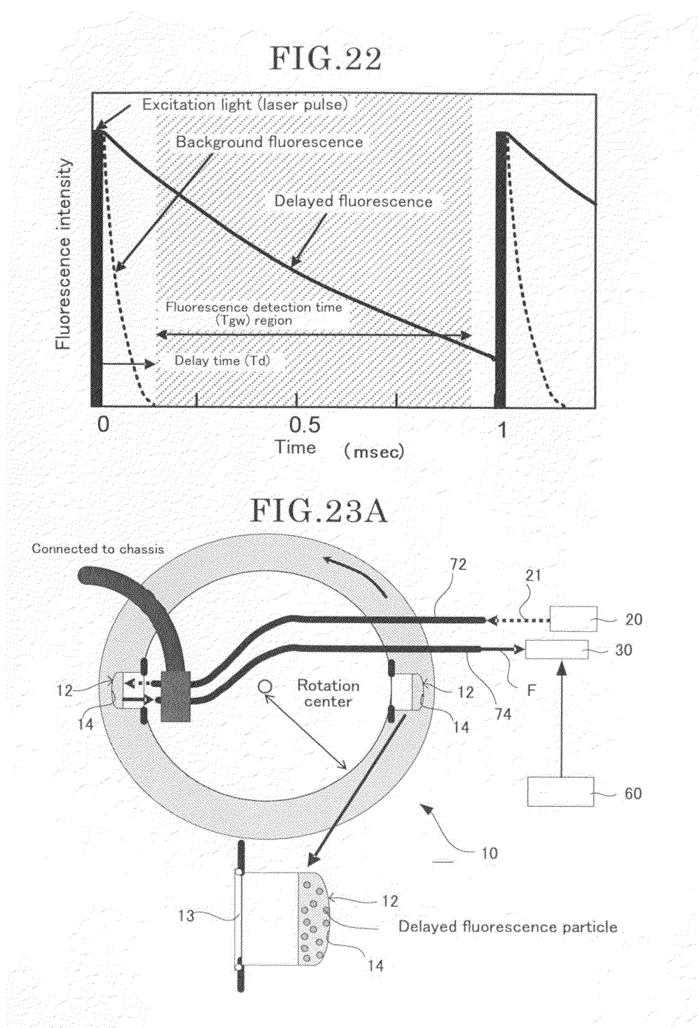

As is shown in FIG. 22, in the time-resolved fluorescence detecting method, the delayed fluorescence pigment is exposed to very narrow pulse light, and the fluorescence is detected when the delayed fluorescence pigment is not exposed to the pulse light. Or, the fluorescence is detected, in a time period from a time point when another time period of (Td) required for the background fluorescence to quench has been passed, to the time point when the next exposure to the pulse light begins.

Since, in this way, by using time-resolved fluorescence detecting method, only the fluorescence from the delayed fluorescence pigment as the fluorescent label can be detected without a harmful influence of the fluorescence from impurities (background fluorescence), the fluorescence detection with less noise and high sensitivity is advantageously performed.

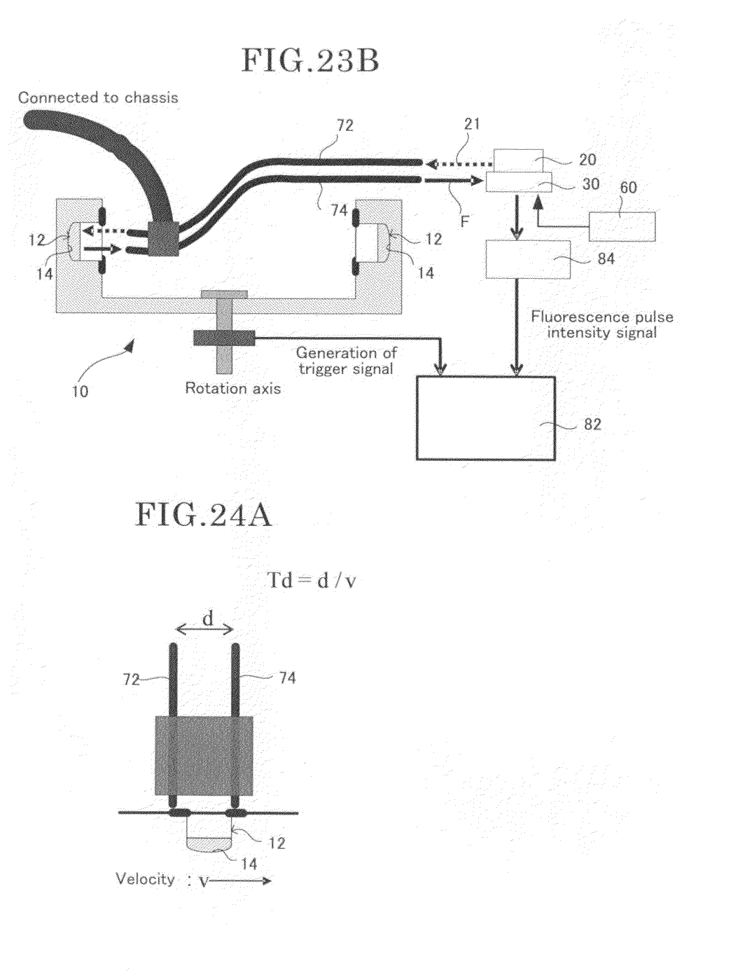

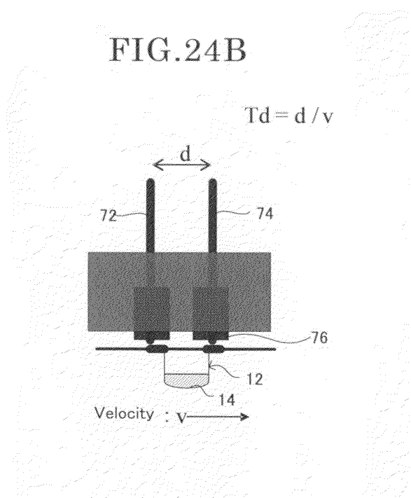

Methods for the detection control by the detection controlling unit include following aspects. For example, in a conventional method, an excitation laser light is cut with an optical chopper to create optical pulses, and at the same time a laser light from a light source such as an LED mounted to the optical chopper is cut with the same optical chopper to create a synchronized signal so that an appropriate delay time is produced, and only the delayed fluorescence can be detected by turning on the photodetector for an appropriate duration of time using this synchronizing signal. In contrast to this, according to the present invention, time-resolved fluorescence detection is conducted more simply, as is shown in FIG. 23A to FIG. 24B described later. That is: two optical fibers are provided in parallel, and an excitation light is emitted from one optical fiber and the fluorescence is detected by the other optical fiber. The objects to be measured are required to be moved at a defined speed in this method, which is contrary to the above described conventional method using an optical chopper, where the objects to be measured are set still and are not required to be moved.

Specifically, in the conventional method, a CW laser light is processed, by an optical chopper with a high rotation speed, to a light with a pulse span of several tens of nanoseconds, with a cycle size of 1 millisecond and used as an excitation light. Simultaneously, trigger electric pulses are generated by the LED and the photodiode associated with the optical chopper, and the trigger electric pulses are inputted to a CCD camera with an image intensifier (II) as a photodetector, and using these trigger electric pulses as the standard, a light gate of the camera is opened for a defined duration with a delay time Td by the functions of the camera, and only the fluorescence from the delayed fluorescence pigment may be detected thereby.

Also another method can be used, in which electric pulse signals are generated by a pulse generator, at the same time as laser light is switched on and off by these signals trigger signals are generated with a defined delay time Td with respect to an electric pulse signal, and the photodetector is switched on and off by these trigger signals, and only the fluorescence from the delayed fluorescence pigment may be detected thereby. For the pulse generator, DG535 from Hamamatsu Photonics K.K. can be used.

### <Unit and Step for Evaluating Fluorescence Intensity>

The fluorescence intensity evaluating unit functions to evaluate the difference in the intensity change of fluorescence between fluorescent particles in the first container and fluorescent particles in the second container.

The fluorescence intensity evaluating step is a step for evaluating the difference in the intensity change of fluorescence between fluorescent particles in the first container and fluorescent particles in the second container.

The fluorescence intensity evaluating step can be conducted appropriately by the fluorescence intensity evaluating unit.

The fluorescence intensity evaluating unit is not restricted particularly and can be selected suitably according to the purpose. For example, the fluorescence intensity evaluating unit is preferably designed such that the data of the fluorescence intensity changes for both of the first and second containers are shown in graphical representations manually or by using a computer for simultaneous display. Alternatively, the he fluorescence intensity evaluating unit may be so configured that the coincidence of the two graphs can be confirmed at a glance, or may be so configured that only the evaluation result is displayed as a phrase, such as “Target Detected.”

In the fluorescence intensity evaluating step, the target may be detected, by putting only the fluorescent label in the first container and putting the fluorescent particle formed from the target (the target, such as a protein, labeled with the fluorescent label) in the second container, and by evaluating the difference in fluorescence intensity change between the fluorescent particles in the first container and the fluorescence particles in the second container.

Furthermore, the occurrence of formation of the complex of the target capturer (antibody) and the target (an antigen) can be determined, by putting the fluorescent particle formed from the target capturer (a target capturer labeled with the fluorescent label, such as a labeled antibody) in the first container and putting the target sample constituted by the fluorescent particle formed from the target capturer (the labeled antibody) and a target (for example, an antigen), in the second container, and by evaluating the difference in fluorescence intensity change between fluorescent particles in the first container and fluorescent particles in the second container. Moreover, detection, diagnosis, etc., or quantification of the target can be performed, by measuring, in advance, the sedimentation time of the fluorescent particles or the number of revolutions for centrifugation with and without the target capturer being captured by the target, and by constructing calibration curves.

### <Additional Members>

Examples of additional members include, for example, a mirror for reflection, a dichroic mirror, and a band-pass filter. When the fluorescent particles are exposed to light from the light irradiation unit, and when the fluorescence generated by the fluorescent particles is led to the fluorescence detecting unit, and so on, these members are preferably provided as needed according to the arrangement of the various units and members in the target detecting apparatus,

Examples of the target detecting apparatus of the present invention will be described below with references to the drawings.

### EMBODIMENT 1

FIG. 8 is a schematic explanatory illustration showing embodiment 1 (basic configuration) of the target detecting apparatus of the present invention. This target detecting apparatus includes at least a centrifugal separator 10 as the centrifugal force giving unit, an excitation light source 20 as the light irradiation unit, and a photodetector 30 as the fluorescence detecting unit.

Centrifugal separator 10 has a centrifugation tube 12 used as the first container and as one of the plurality of the second containers. As in embodiment 4 described later, the centrifugation tube 12 is placed along the rotation circumference of the centrifugal separator 10. While the excitation light source 20 and the photodetector 30 are fixed to the centrifugation tube 12, only the centrifugation tube 12 is rotated by the centrifugal separator 10. Further, a gold film 14 is formed at the inner bottom and side surfaces of the centrifugation tube 12. The centrifugation tube 12 stands in a direction perpendicular to the horizontal plane while the centrifugal separator 10 is still, and moves to orient in a direction parallel to the horizontal plane along with centrifugation so that the sample in the centrifugation tube 12 is exposed to light from the excitation light source 20. Meanwhile, since the amount of solution put in the container (the centrifugation tube 12) is generally very small, the container may be horizontally held before centrifugation in view of the surface tension of the solution.

Samples to be contained in the centrifugation tube 12 are of various types, including a single labeled antibody as the fluorescent particles and a combination of a labeled antibody and an antigen, and generate many distinct fluorescence pulses. Therefore, a method is preferably applied, in which, in order to discriminate the fluorescence pulses according to the centrifugation tubes, electric signals synchronized with the rotation of the centrifugal separator 10 are generated as in the case of embodiment 4 described later, thereby the centrifugation tube with a fluorescent particle being excited is discriminated from the others, and each fluorescence pulse detected can be related to the particular centrifugation tube.

Further, when impurities are mingled in the sample, in order for the impurities not to reach the gold film faster than the fluorescent particles, a filter is preferably put in the container, by which the impurities with particle diameters larger than those of the fluorescent particles are removed.

The excitation light source 20 is preferably so configured that the excitation light 21, which is a continuum light at the same time as a laser light, is emitted into the centrifugation tube 12. In FIG. 8, the excitation light 21 from the excitation light source 20 is reflected perfectly by the dichroic mirror 22, and is further reflected by the reflection mirror 24 and is led into the centrifugation tube 12.

The photodetector 30 is preferably so configured that it is subjected to the fluorescence F generated by the fluorescent particle. In FIG. 8, the fluorescence F is reflected by the reflection mirror 24 and is led into the photodetector 30.

Meanwhile, the reflection mirror 24 may be a concave mirror, and a part of the dichroic mirror 22 may be a small mirror with an area of approximately equal to a cross-section of the laser light beam. Note, however, that a band-pass filter capable of transmitting only the fluorescence F is required to be put in immediately before the photodetector, because, in this case, the photodetector 30 is possibly exposed to the excitation light 21.

### EMBODIMENT 2

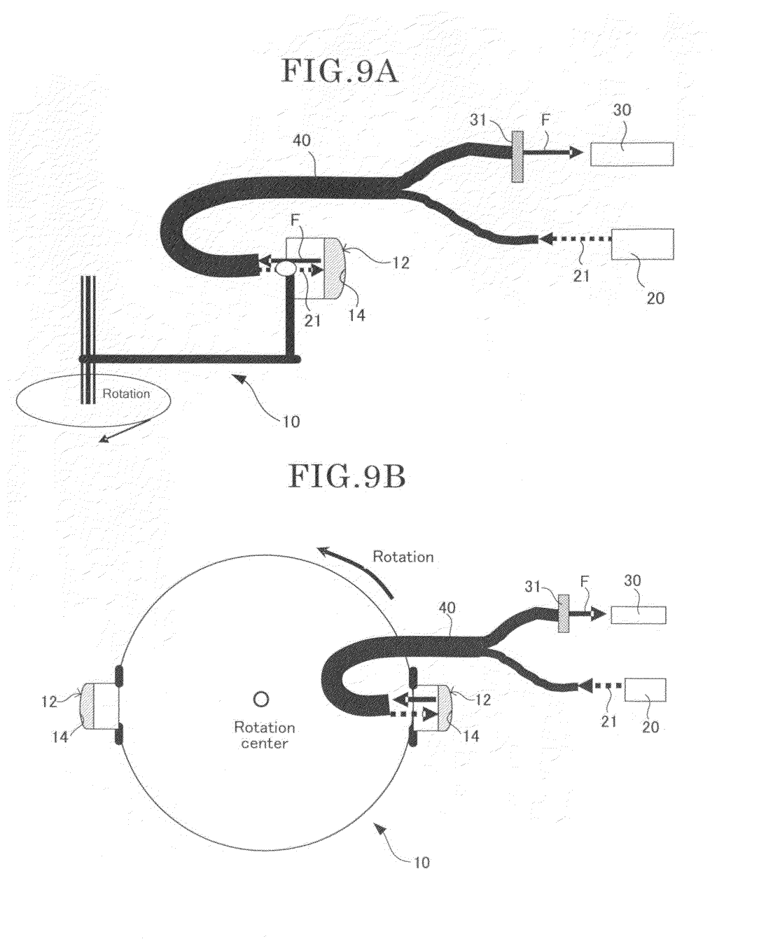

Since the fluorescence F is not a coherent light, such as a laser light, at the position far from the centrifugation tube 12, it is so attenuated that its detection may be difficult to some degree. In such a case a method is preferably used, in which optical fibers are configured, as are shown in FIGS. 9A and 9B, and the fluorescence F is taken into the optical fibers at the positions as close to the entrance of the centrifugation tube 12 as possible. FIG. 9A is a side view showing the embodiment 2 of the target detecting apparatus of the present invention, and FIG. 9B is a top view showing the embodiment. In this configuration, the tip of a complex optical fiber 40 is placed in the positions as close to the entrance of the centrifugation tube 12 as possible, and an optical fiber with a core diameter of 100 micrometer is used for the emission of the excitation light 21, and a bundle made up of a plurality of an optical fiber with a core diameter of 400 micrometers to 800 micrometers is used for the detection of the fluorescence F. In addition, immediately before the photodetector 30, a filter 31 is placed.

### EMBODIMENT 3

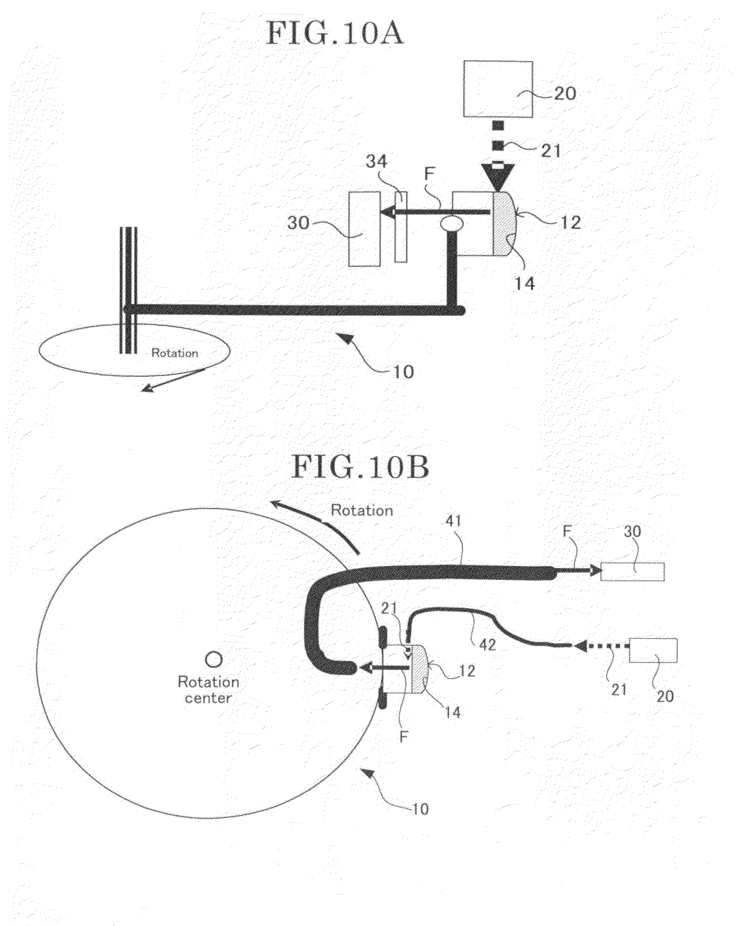

Meanwhile, when the internal diameter of the centrifugation tube 12 is small and the side of the centrifugation tube is made of the material transparent for the excitation light 21, the excitation light 21 is preferably allowed to be emitted from the side of the centrifugation tube 12, as are illustrated in FIG. 10A and FIG. 10B. FIG. 10A is a side view showing the embodiment 3 of the target detecting apparatus of the present invention, and FIG. 10B is a top view of the target detecting apparatus using optical fibers with, otherwise, the same configuration in FIG. 10A. In this configuration, the excitation light 21 from the excitation light source 20 is allowed to be emitted from the side of the centrifugation tube 12 by using the optical fiber 42, and the fluorescence F generated by the fluorescent particle excited by the excitation light 21, is subjected to a band-pass filter and, then, is detected by the photodetector 30 through the optical fiber 41 directly. In this case, an efficiency of emission of the fluorescence to the photodetector 30 may be advantageously increased.

The following is a description of a function of the target detecting apparatus of the embodiment 1 to embodiment 3. First, a sample containing the fluorescent particle is put in the centrifugation tube 12 in the centrifugal separator 10, and a centrifugal force is given to the fluorescent particle by rotating the centrifugation tube 12. With a progress of the rotation, the centrifugation tube 12 moves to lie in the direction parallel to the horizontal plane, which enables the excitation light 21 from the excitation light source 20 to be emitted into the centrifugation tube 12, and a fluorescence is generated by the fluorescent particle exposed to the excitation light 21 and excited thereby. The fluorescent particle is given the centrifugal force and is made contact with a gold film 14 formed on the base and the side of the centrifugation tube 12. Then, energy of the fluorescent particle shifts to the gold film, and the fluorescent particle quenches the fluorescence. Photodetector 30 detects this intensity change of the fluorescence. The intensity change of fluorescence can be detected by the method described above (see FIG. 6 and FIG. 7).

### EMBODIMENT 4

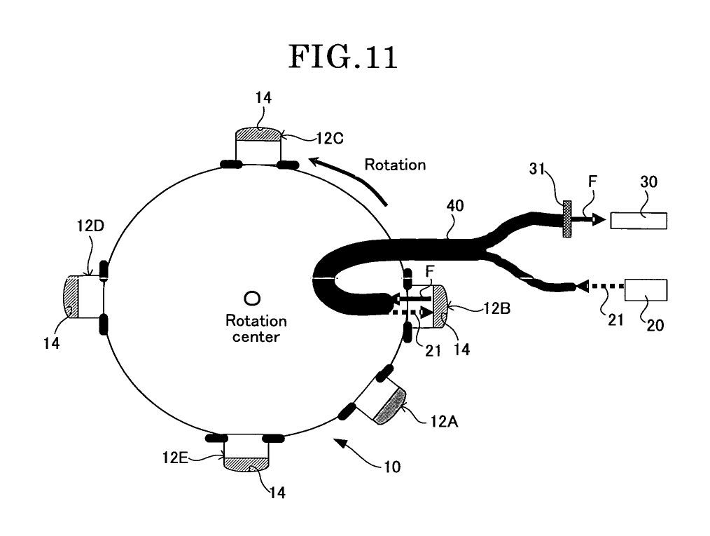

FIG. 11 is a schematic explanatory illustration showing embodiment 4 of the target detecting apparatus of the present invention. In this target detecting apparatus, a centrifugal separator 10 has five centrifugation tubes 12A, 12B, 12C, 12D, and 12E arranged along the rotation circumference. Specifically in practice, the centrifugation tubes are configured so as to be rotated stably. Among these five centrifugation tubes, while a gold film is not formed in centrifugation tube 12A, the gold film 14 is formed on the inner bottom and side surfaces the other four centrifugation tubes 12B, 12C, 12D, and 12E. And while samples to be measured (samples containing the fluorescent particles) are put in the centrifugation tube 12B, 12C, 12D, and 12E, the fluorescent label with higher concentration than those of the samples to be measured is put in the centrifugation tube 12A. In this case, since the fluorescent label in the centrifugation tube 12A continues to generate fluorescence, even after the contact with the base of the centrifugation tube 12A, where no gold film is formed, by the centrifugal force, this fluorescence can be advantageously used as a signal standard by which the positions of other fluorescence can be made clear in relation to the position of this fluorescence.

Although in the above case, as a light signal synchronized with the rotation for a discrimination of the fluorescence is a light signal using the centrifugation tube 12A which constantly generate a strong fluorescence, the discrimination of the fluorescence according to the centrifugation tubes may be conducted alternatively by generating an electric signal every time when the centrifugal separator 10 comes to a certain position in the rotation circumference. In addition, for recording data at such high speed, a data logger having a sampling time sufficiently shorter than the rotation period of the centrifugal separator 10 may be used.

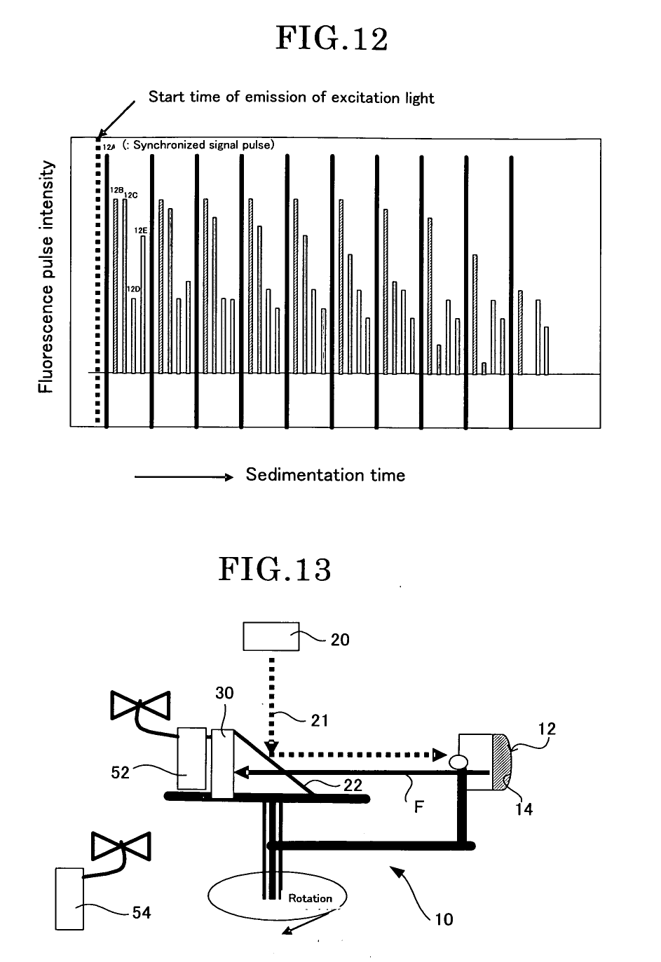

An example of the result of detection of the fluorescence intensity by the photodetector 30 in the target detecting apparatus of embodiment 4 is shown in FIG. 12. FIG. 12 shows changes in the fluorescence intensities with time that were measured simultaneously for the four samples. For the construction of the figure, sedimentation times of the fluorescent particles required for its fluorescence pulse intensity to attenuate from the initial value to a particular value are calculated for each sample and recorded. By using FIG. 12, the state of the fluorescent particles can be judged from peak value of the fluorescence pulse intensity for each sample. For example in an antigen-antibody reaction, in the case where an antibody is fixed to the wall of the container, since an antigen diffuses to reach and react to the antibody, time required for the antigen-antibody reaction to occur becomes longer. In contrast to this case, in the case of this embodiment, time required for the reaction to occur is shorter, and the time required for the fluorescence to be quenched becomes shorter by the centrifugal force giving unit.

In addition, when the fluorescent particles have a very small particle diameter and do not contact with the gold film sufficiently within this range of the number of revolutions, the fluorescence pulse continues to be generated irrespective of the number of revolutions. Meanwhile, as the particle diameter of the fluorescent particle becomes larger, the frequency with which the particle collides to the base of the centrifugation tube becomes higher even by a small number of revolutions, and the degree to which fluorescence is quenched becomes higher. For this reason, the number of revolutions and amounts of the samples containing the fluorescent particles are preferably set for each particular measurement procedure.

### EMBODIMENT 5

In the target detecting apparatuses of the embodiment 1 to embodiment 4, a number of data sets corresponding to the number of the centrifugation tubes configured along the rotation circumference can be measured simultaneously. However, when a sample is measured simply, or when the intensity change of the fluorescence is measured continuously against the sedimentation time of the fluorescent particle or the number of revolutions of the centrifugal separator, the target detecting apparatus having a configuration shown in FIG. 13 is preferably used.

FIG. 13 is a schematic explanatory illustration showing the embodiment 5 of the target detecting apparatus of the present invention. In this target detecting apparatus, a dichroic mirror 22 is placed on the center of the axis of rotation of the centrifugal separator 10, an excitation light 21 is emitted from an excitation light source 20 placed directly above the dichroic mirror, and it is emitted into one centrifugation tube 12 continuously thereby, even when the centrifugal separator 10 is rotating. A photodetector 30 is fixed to the rotation shaft of the centrifugal separator 10 and rotates with the centrifugation tube 12. A fluorescence generated by the fluorescent particle exposed to the excitation light 21 is transmitted through the dichroic mirror 22, and is detected by the photodetector 30 placed directly behind the dichroic mirror. In this case, since the photodetector 30 rotates at a high speed above the rotation shaft of the centrifugal separator 10, a fluorescence intensity signal is transmitted by a fluorescence intensity signal transmitter 52 by such wireless transfer means as radio waves and infrared radiation, and is detected by the fluorescence intensity signal receiver 54 placed near the target detecting apparatus.

### EMBODIMENT 6

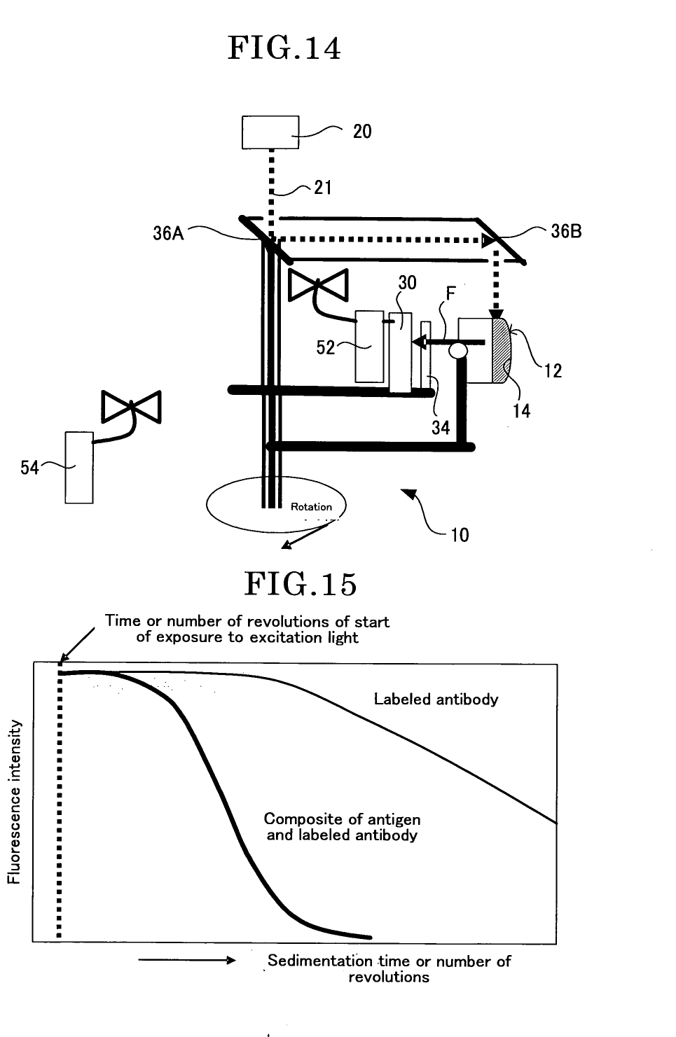

FIG. 14 is a schematic explanatory illustration showing the embodiment 6 of the target detecting apparatus of the present invention. This target detecting apparatus has a configuration similar to that of the embodiment 5, except that the excitation light 21 is emitted from the side of the centrifugation tube 12.

As is shown in FIG. 14, a rotatable reflection mirror 36A is placed above the center of the rotation shaft of the centrifugal separator 10, and a rotatable reflection mirror 36B is so placed that it is located directly above and side-on the centrifugation tube 12 when the centrifugation tube 12 moves to lie in the direction parallel to the horizontal plane by a centrifugal force. In addition, the fluorescence from the fluorescent particle is detected directly by the photodetector 30 through a band-pass filter 34.

An example of results of detection of the fluorescence intensity by the photodetector 30 in the target detecting apparatuses of embodiments 5 and 6 is shown in FIG. 15. FIG. 15 shows a change of a fluorescence intensity, plotted against a sedimentation time or a number of revolutions of the centrifugal separator, of a labeled antibody from the duplicate measurements conducted under the same conditions, for solution A containing only the labeled antibody and for solution B in which a complex is formed from the labeled antibody and an antigen by an antigen-antibody reaction. When the number of revolutions is taken as a horizontal scale, the time required for the number of revolutions to reach the maximum is constant, and when the sedimentation time is taken as a horizontal scale, the number of revolutions is constant. In this way, by means of the target detecting apparatuses of the embodiments 5 and 6, a continuous change of fluorescence intensity from one centrifugation tube can be detected with high sensitivity.

### EMBODIMENT 7

FIG. 23A is a top view schematic illustration of the embodiment 7 of the target detecting apparatus of the present invention which is capable of detecting fluorescence according to the time-resolved fluorescence detection method, and FIG. 23B is a side view schematic illustration thereof. This target detecting apparatus includes at least a centrifugal separator 10 as the centrifugal force giving unit, an excitation light source 20 as the light irradiation unit, a photodetector 30 as the fluorescence detecting unit, and the detection controlling unit 60.

The centrifugal separator 10 has centrifugation tubes 12 as the first container and the second container, and centrifugal tubes 12 are placed along the rotation circumference of the centrifugal separator 10. Inside the centrifugation tube 12, a gold film 14 is formed. In addition, the centrifugation tube 12 may be sealed by an air-tight sealing glass 13.

Furthermore, the target detecting apparatus of the embodiment 7 provides an optical fiber 72 for emitting light from the excitation light source 20, and an optical fiber 74 for detecting the fluorescence by the photodetector 30. And the two optical fibers are placed with a distance d between them along the rotation circumference of the centrifugal separator 10. The distance d and the rotation velocity v of the centrifugation tube 12 may be adjusted suitably, and based on these adjustments the interval of the light from the optical fiber 72 exposed to the delayed fluorescence particle is determined. As is shown in FIG. 24A and FIG. 24B, delay time Td (time required for the background fluorescence to be quenched; see FIG. 22) is determined by the following Equation (4).

Td=v/d Equation (4)

As is shown in FIGS. 24A and 24B, the optical fibers 72 and 74 are preferably placed as close to the centrifugation tubes 12 as possible. The optical fiber 72 and the optical fiber 74 may not be placed in parallel, so as not to lead the light from the optical fiber 72 to the optical fiber 74 for detecting the fluorescence.

As is shown in FIG. 24A, for the optical fibers 72 and 74, an optical fiber with a core diameter of 100 μm to 1,000 μm (as a material for the optical fibers, quartz, plastic, etc. can be selected suitably) and with its tip polished flatly may be used, or as is shown in FIG. 24B, a fiber collimator 76 may be introduced so as to expose inside of the centrifugation tube 12 to an excitation light uniformly, and to collect the fluorescence from inside the centrifugation tube 12.

In addition, a lens optical system suitable for the emission of the excitation light and for the collection of the fluorescence (for example, a cylindrical SELFOC lens, an aspheric lens, etc. can be suitably used) may be placed at the tips of the optical fibers 72 and 74.

As is shown in FIG. 23A, when the centrifugal separator 10 is operated at a high speed, the delayed fluorescence particle in the centrifugation tube 12 is exposed to an excitation light from the optical fiber 72 used for light emission. The centrifugation tube 12 comes to the position directly below the optical fiber 74 used for detecting the fluorescence Td after the excitation of the delayed fluorescence particle, and the fluorescence from the delayed fluorescence particle is detected. Or an alternative method may be applied, in which the detection controlling unit 60 is controlled by the controlling signals from the centrifugal separator 10, the controlling signals are transmitted to the photodetector 30, and the fluorescence is detected by the photodetector 30 thereby. Here, as is shown in FIG. 23B but not in FIG. 23A, a sharp electric pulse may be generated for every single rotation of the centrifugation tube 12 containing a sample, and may be used as a trigger signal to be inputted into the input terminal for synchronizing signals of the oscilloscope 82, and the fluorescence pulse obtained from the photodetector 30 may be amplified once by subjecting to the amplifier 84 and may be inputted into the signal input terminal of the oscilloscope 82. Since the horizontal axis of the oscilloscope 82 is time axis, the fluorescence pulse may be observed on the screen display of the oscilloscope a certain time after or before the trigger signal, and with the increase of the number of revolutions of the centrifugal separator 10, the fluorescence pulse intensity may become smaller. The time axis (X axis) is preferably adjusted so that the two fluorescence pulses from each of the two centrifugation tubes 12 containing the samples may be constantly seen on the oscilloscope screen display.

While a conventional time-resolved fluorescence detecting method conducts measurements of fluorescence intensity like that shown in FIG. 22 using laser pulse light as the light from the light irradiation unit, in this embodiment, since time-resolving is done by using a continuum light and by high-speed rotation of the centrifugation tubes 12 containing samples, the apparatuses can be advantageously simplified and downsized.

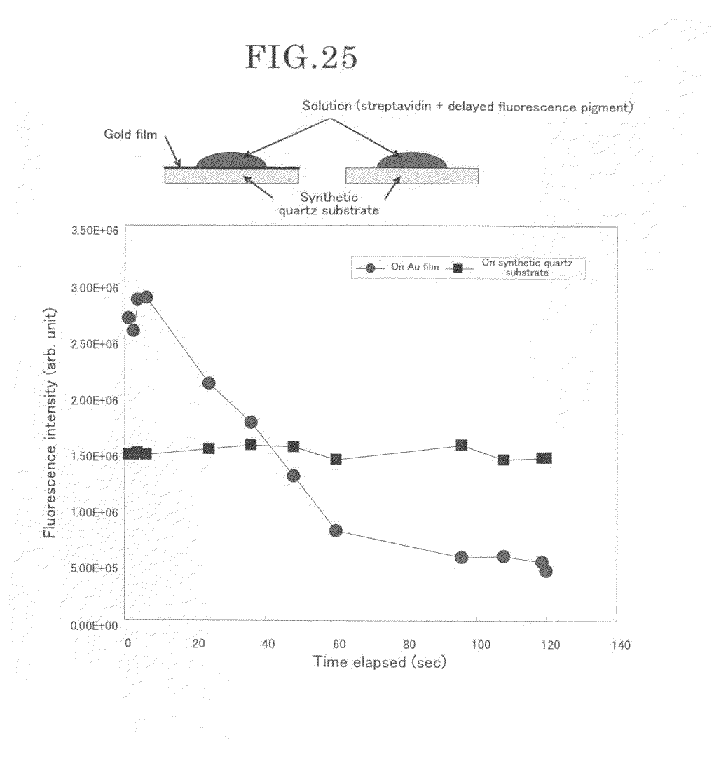

FIG. 25 shows changes in fluorescence intensity for the delayed fluorescence particles on the synthetic quartz substrate and on the gold film. The fluorescence intensity during the period of about 2 min to 3 min (in which period the solution dries up) was measured, by dropping 0.5 μL aqueous solution containing the streptavidin labeled with the delayed fluorescence pigment onto each of the synthetic quartz substrate and the gold film formed on the synthetic quartz substrate, and by setting the delay time Td as 0.2 milliseconds.

As is seen in FIG. 25, on the synthetic quartz substrate, the fluorescence intensity is not affected by evaporation and desiccation of the solution and is kept at almost the same level. In contrast to this, on the gold film, as a result of volume reduction of the solution due to evaporation, the collision frequency of the delayed fluorescence particle to the gold film increases and the fluorescence intensity is seen to decrease linearly till about 60 sec after the start of measurement. And, since the fluorescence is reflected by the gold film, the intensity of the fluorescence is seen to be stronger than that on the synthetic quartz substrate.

In this experiment, although the fluorescence is detected by a high sensitivity CCD camera, an optical system used is the same as that in the embodiment 7. Therefore, the decrease in the fluorescence on the gold film is considered to be caused by an increase in the collision frequency due to the slight reduction in the solution volume. This proves that the apparatus of the embodiment 7 is an apparatus capable of detecting targets, since when the collision frequency is increased in the apparatus with the configuration of the embodiment 7, the amount of fluorescence decreases.

According to the target detecting apparatus of the present invention, it is possible to detect, in a short time and efficiently, fluorescent particles that produce fluorescence upon exposure to light, such as fine particles of various targets (for example, proteins and antigens) labeled with a fluorescent label and of capturers labeled with a fluorescent label (for example, antibodies) capable of combining with the targets.

The target detecting apparatus of the present invention can be used in a wide range of the fields including medical science and biology, etc., and can be further applied in medical diagnosis, for example, diagnosis of diabetes, hypertension, hyperlipemia, and other multifactorial disorders in general.

The target detecting method of the present invention is able to detect, in a short time and efficiently, fluorescent particles formed from a protein, etc. labeled with a fluorescent label, and can be applied appropriately in a wide range of fields including medical science and biology, etc.

### EXAMPLES

Examples of the present invention will be described below; however, the present invention is not restricted by the following Examples in any way.

### Example 1

### Experiment to Confirm the Phenomenon of Fluorescence Quenching

First, a 1×10⁻⁸M aqueous solution of the fluorescent particle synthesized from the rare earth element fluorescent pigment (DTBTA-Eu³⁺), as the fluorescent label, introduced into streptavidin (S.A.), as the target, was prepared.

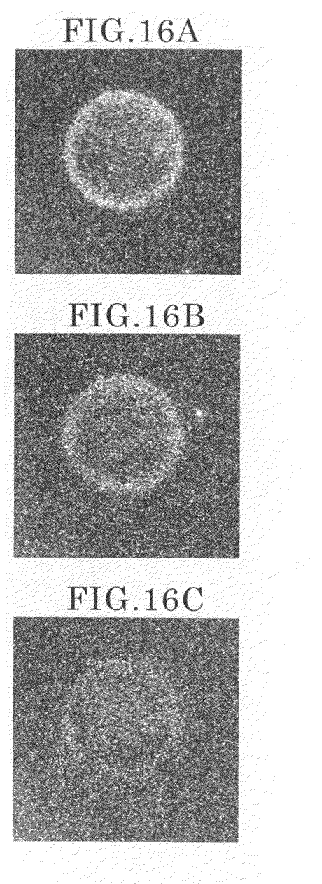

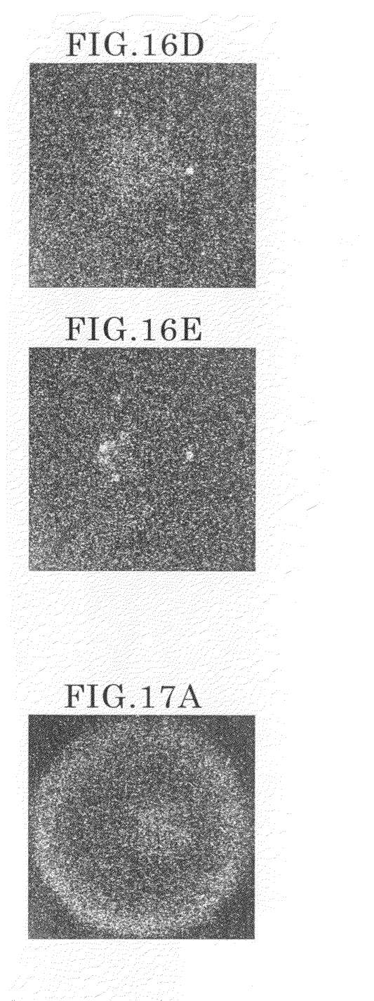

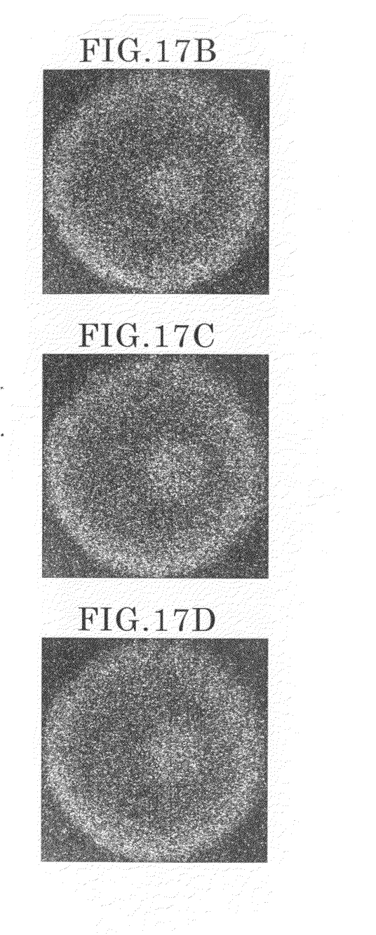

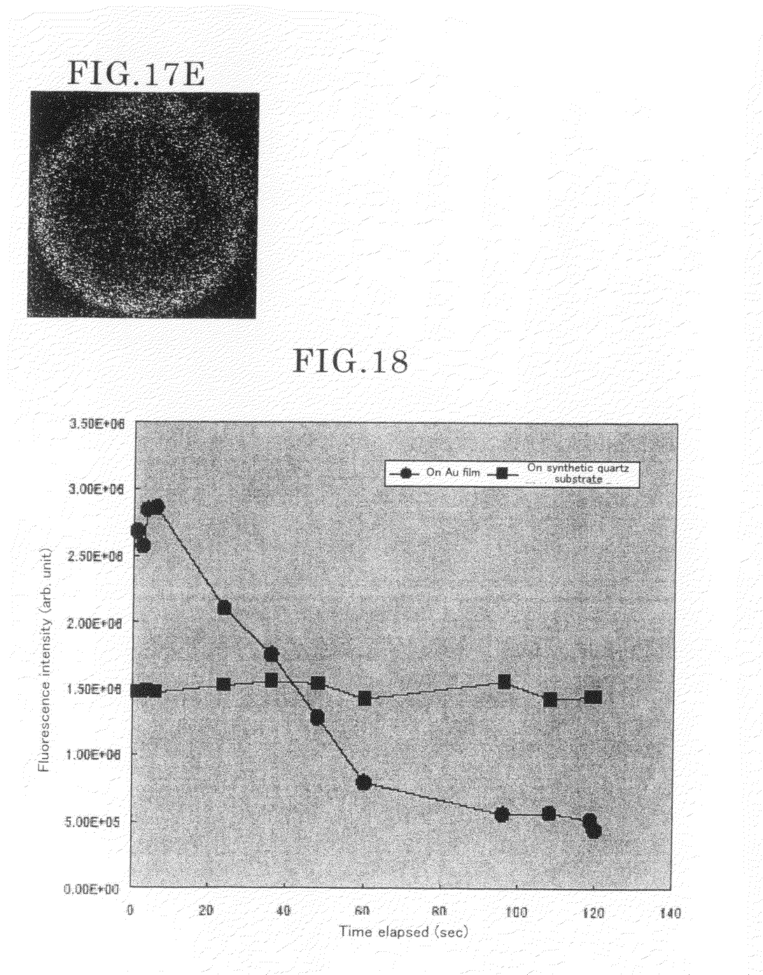

Then, 0.5 μL of an aqueous solution of the fluorescent particle obtained was dropped onto the gold film having a thickness of 1 μm and onto the synthetic quartz substrate having a thickness of 1 mm. The aqueous solution of fluorescent particle was exposed to a laser light having a wavelength of 325 nm, and the fluorescence generated by the fluorescent particle was measured, for about two minutes, by taking a moving image of it. The changes in fluorescence level for the fluorescent particles on the gold film are shown in FIGS. 16A to 16E, and the changes in fluorescence level for the fluorescent particles on the synthetic quartz substrate are shown in FIGS. 17A to 17E. Note that size of spot is larger for a spot in FIG. 17A to FIG. 17E than for that in FIGS. 16A to 16E because of the difference in surface tension.

As is shown in FIGS. 16A to 16E, the fluorescence generated by the fluorescent particles on the gold film was strong initially (see FIG. 16A), it was gradually attenuated with time (see FIG. 16B to FIG. 16D), and after about two minutes it was quenched with the aqueous solution evaporated and dried completely and with the fluorescent particle contacted completely with the gold film (see FIG. 16E). Note that the phenomenon of fluorescence quenching is not due to degeneration of the fluorescent pigment.

Meanwhile, as is shown in FIGS. 17A to 17E, the fluorescence generated by the fluorescent particles on the synthetic quartz substrate was not quenched. Note, however, that about two minutes after the start of the experiment, the aqueous solution was completely evaporated and dried.

In addition to the pictures of the fluorescence shown in figures described above, a relationship between the time elapsed (which corresponds to the sedimentation time or the number of revolutions of the centrifugal separator) and the fluorescence intensity is shown in FIG. 18. From FIG. 18, it was found that, while the fluorescence intensity on the gold film was attenuated to the background level about two minutes after the start of the experiment, the fluorescence intensity on the synthetic quartz substrate was maintained roughly constant.

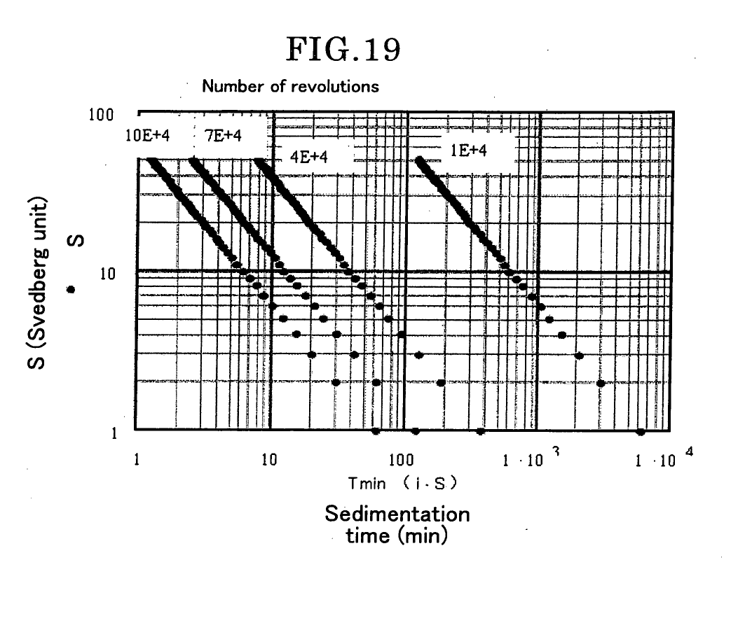

In order to sediment the fluorescent particle to the bottom of the container (or centrifugation tube) by centrifugation under the conditions that the internal diameter of the centrifugation tube is 3 mm, the charge depth of the solution to be measured (the sample containing the fluorescent particle) is 2 mm, the radius of the rotation is 5 cm, the fluorescence pulse width is several tens of microseconds to several hundreds of microseconds, it is necessary to increase the number of revolutions as shown in FIG. 19. The sedimentation coefficient S is a measure indicating the tendency of a protein to sediment, and is about 3 to 12 for simple proteins (for example, is 4.5 for albumin). Those with smaller S require higher speeds for the centrifugal separator.

Since the fluorescence generated by the fluorescent particles on the gold film is immediately quenched only by allowing them to contact the gold film rather than pressing them against the gold film, the overall fluorescence intensity decreases with increasing frequency at which the fluorescent particles contact with the gold film.

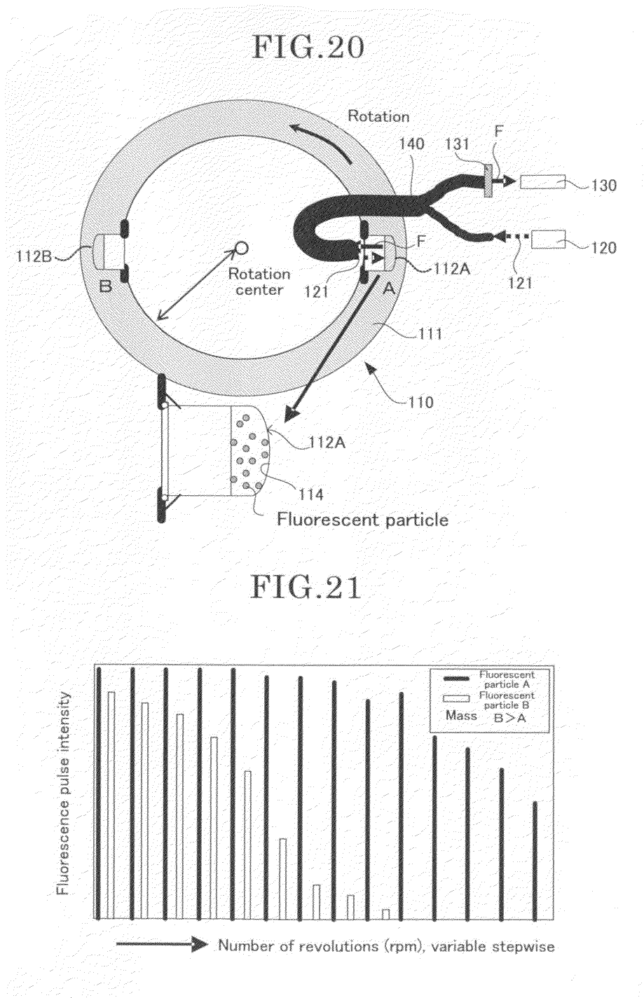

The fluorescent particles existing in the close vicinity of the gold film are constantly repeating a cycle of contacting with and leaving from the gold film by thermal motion. Thus the fluorescence intensity observed in the vicinity of the entrance of the centrifugation tube is expressed as a summation of the intensity of fluorescence from the fluorescent particles repeating the cycle (OP1) and the intensity of fluorescence from the fluorescent particles existing in a position far from the gold film (OP2). When the amount of the solution to be measured is large, mainly the fluorescence from OP2 is detected, and the apparatus needs to be designed according to the principle of centrifugation. On the other hand, when the amount of the solution to be measured and to be contained in the centrifugation tube is reduced, the centrifugation tube is sealed for prevention of evaporation of the solution, and the solution is allowed to exist in close vicinity of the gold film, the fluorescence detected becomes mainly a component of OP1. The light of OP1 is a light from equilibrium of light quenching and light generation caused by the thermal motion of the fluorescent particles. The intensity change of fluorescence that mainly derives from OP1 can be detected by means of the target detecting apparatus shown in FIG. 20.

### —Detection of Fluorescent Particle—

The target detecting apparatus shown in FIG. 20 includes at least a centrifugal unit 110 as the centrifugal force giving unit, a CW excitation light source 120 as the light irradiation unit, a photodetector 130 as the fluorescence detecting unit.

The centrifugal unit 110 has a metal circular disk 111 of a doughnut shape, to which a centrifugation tube 112A as the first container and a centrifugation tube 112B as the second container can be embedded in the direction parallel to the horizontal plane. The metal circular disk 111 can be revolved around the rotation axis of the centrifugal unit 110, and the revolution radius is 5 cm. And the metal circular disk 111 has holes 111A and 111B on its side. Each of the holes is so constructed that each contains each of the centrifugation tube 112A and 112B with the openings of the tubes facing each other. The centrifugation tubes 112A and 112B have an internal diameter of 3 mm and a depth of 5 mm, and have a gold film 114 of a thickness of 1 μm formed inside.

Further, a complex optical fiber 140 is used with its tip placed in as close vicinity to the openings of the centrifugation tube 12 as possible. In the complex optical fiber 140, an optical fiber of a core diameter of 100 μm is used for the emission of the excitation light 121 from the CW excitation light source 120, and a bundle of an optical fiber of a core diameter from 400 μm to 800 μm is used for the detection of the fluorescence F by the photodetector 130. And immediately before the photodetector 130, a filter 131 is placed.

In addition, since the velocity of the fluorescent particles in thermal motion is random and influenced by their mass and the temperature, etc., the target detecting apparatus may be equipped suitably with a known temperature stabilizing unit, a known cooling unit, and other units.

Fluorescent particle aqueous solution A containing only fluorescent particle A of the rare earth element fluorescent pigment (DTBTA-Eu³⁺) as the fluorescent label was put in the centrifugation tube 112A, and prepared fluorescent particle aqueous solution B (aqueous solution containing the fluorescent particle B synthesized from the rare earth element fluorescent pigment (DTBTA-Eu³⁺) as the fluorescent label introduced into streptavidin (S.A.) as the target) was put in the centrifugation tube 112B. In this process, the fluorescent particle aqueous solutions A and B were put so that they had a solution depth of 0.7 mm (the amount contained is 5 μL). Since the fluorescent particle aqueous solutions A and B have a very small amount of 5 μL, they are fixed to the inner bottom of the centrifugation tubes 112A and 112B due to their surface tension, and do not flow out when the centrifugation tubes 112A and 112B are set horizontally.

Then, each of the fluorescent particles A and B was given a weak centrifugal force toward the gold film by revolving the centrifugation tubes 112A and 112B by the centrifugal unit 110. And each of the fluorescent particles A and B is exposed to the excitation light 121 from the CW excitation light source 120, and is excited, and the fluorescence generated by the fluorescent particles A and B was detected by the photodetector 130. By the centrifugal force, the contact frequency with the gold film of the fluorescent particle generating the light of an OP1 component increased, and the fluorescence intensity as a whole decreased thereby. The decreased amount of the fluorescence intensity depended on the mass of the fluorescent particle. FIG. 21 shows a result of a comparison between the fluorescent particle aqueous solution B containing the fluorescent particle B with a larger mass than the particle A and the fluorescent particle aqueous solution A containing the fluorescent particle A. FIG. 21 is an imaginary illustration, in which the fluorescence pulse intensity is expressed as a vertical scale, and the number of revolutions of the centrifugal unit 110 is expressed as a horizontal scale, and the number is varied stepwise.

In this way, by evaluating the difference of the fluorescence intensity change between the fluorescent particles with different masses, a qualitative analysis, such as a detection of the various targets, such as protein, can be conducted. In addition, since the set of fluorescent particle aqueous solutions A and B can be constantly used and the experiments can be compared under the same conditions, the accuracy of measurement, the resolution performance (expressing the degree of mass difference that can be detected), and others may be improved. Furthermore, the number of revolutions of the centrifugal unit 110 needs not to be raised to a high speed expected in the principle of the centrifugation and may be 10,000 rpm or less. Moreover, since in the target detecting apparatus of the example 1 the sample solution can be contained in the centrifugation tube by using surface tension, the amounts of the various samples, such as blood, required for the analysis can be advantageously made small.

Similarly, fluorescent particle aqueous solution A containing only fluorescent particle A of the fluorescent pigment (Cy3) as the fluorescent label was put in the centrifugation tube 112A, and prepared fluorescent particle aqueous solution B (aqueous solution containing the fluorescent particle B synthesized from the fluorescent pigment (Cy3) as the fluorescent label introduced into streptavidin (S.A.) as the target) was put in the centrifugation tube 112B. In this process, the fluorescent particle aqueous solutions A and B were put so that they had a solution depth of 0.7 mm (the amount contained is 5 μL). Then, each of the fluorescent particles A and B was given a weak centrifugal force toward the gold film by revolving the centrifugation tubes 112A and 112B by the centrifugal unit 110. And each of the fluorescent particles A and B is exposed to the excitation light 121 from the CW excitation light source 120 for excitation, and the fluorescence generated by the fluorescent particles A and B was detected by the photodetector 130. As a result, the contact frequency with the gold film of the fluorescent particle generating the light of an OP1 component increased, and the overall fluorescence intensity decreased thereby. FIG. 21 shows a result of a comparison between the fluorescent particle aqueous solution B containing the fluorescent particle B with a larger mass than the particle A and the fluorescent particle aqueous solution A containing the fluorescent particle A.

### Example 2

### Comparative Experiment of Fluorescence Intensity Change between Fluorescent Pigment and Delayed Fluorescence Pigment

First, DTBTA-Eu³⁺ and BPTA-Tb³⁺ as the delayed fluorescence pigment, and Cy3 as the fluorescent pigment were prepared. Then, a solution of each of the three pigments (the concentration is 1×10⁻⁸M, the spot amount is 0.3 μL) was dropped onto the synthetic quartz substrate and onto the gold film formed on synthetic quartz substrate, was dried and exposed to an excitation light periodically, and a finite time (a delay time, Td) after the exposure to the excitation light the fluorescence intensity generated was detected by a photodetector.

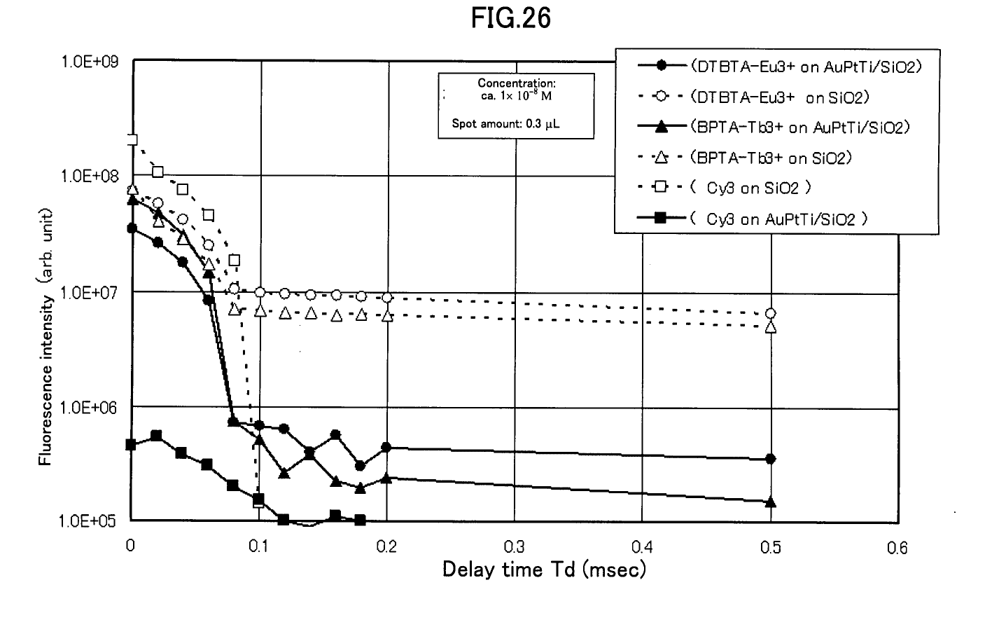

Here, DTBTA-Eu³⁺ and BPTA-Tb³⁺ as the delayed fluorescence pigment were excited by a laser light source of a wavelength of 325 nm, and Cy3 was excited by a laser light source of a wavelength of 515 nm. These fluorescence intensity changes were shown in FIG. 26. In FIG. 26, results of pigments dropped onto the synthetic quartz substrate are shown as dotted lines, and the results of the pigments dropped onto the gold film formed on the synthetic quartz substrate are shown as solid lines. The excitation light was emitted during the initial period of about 0.08 milliseconds in the horizontal axis of FIG. 26, and was quenched completely afterwards.

The two delayed fluorescence pigments were generating strong fluorescence even after the laser light was quenched completely. And the fluorescence intensities of the two delayed fluorescence pigments have values, on the gold film, one digit less than those on the synthetic quartz substrate. The Cy3 generated fluorescence while it was exposed to a laser light, and immediately quenched it after the laser light was quenched. However, the fluorescence intensities of the Cy3 are one order or more of magnitude less on the gold film than on the synthetic quartz substrate.

During the initial period of 0.08 milliseconds (delay time), the fluorescence from the delayed fluorescence pigments was coexisting with the background fluorescence. Therefore, in the case using Cy3, when the sample with easy background fluorescence production is labeled, it is considered that the background fluorescence is difficult to be separated from the signal fluorescence.

### —Detection of Delayed Fluorescence Particle—

Delayed fluorescence particles are detected using the target detecting apparatus of the embodiment 7 shown in FIGS. 24A and 24B. When the distance d between the optical fiber 72 and the optical fiber 74 is set as 1 cm and the delay time Td (see FIG. 22) is set as 0.2 milliseconds, the rotation speed of the centrifugal separator 10 is calculated as 50 m/sec. Further, the distance from the center of the centrifugal separator 10 to each centrifugation tube 12 (the rotation radius) is set as 10 cm, the number of revolutions is calculated as about 3,000 rpm.

Meanwhile, in order to increase the collision frequency of particles to the gold film, it is preferable that the range of the number of revolutions can be set as broad as possible, with the maximum being several tens of thousands rpm in practice, though it may depend also on the mass of the fluorescent particles. Furthermore, in this case, a holding part capable of varying the optical fiber distance d according to the number of revolutions desired or several kinds of holding parts corresponding to the distances d is preferably made. Specifically, the optical fiber distance d is preferably set as from 5 mm to 20 mm, and the number of revolutions is preferably varied in the range from about 500 rpm to about 20,000 rpm.

In this Example, since the fluorescence from the delayed fluorescence pigment was detected after a lapse of the delay time Td and influences from the fluorescence from impurities (background fluorescence) could be eliminated, fluorescence could be detected with higher sensitivity and less noise.

According to the present invention, it is possible to solve the problems of the related arts and to provide an apparatus and method for detecting targets, which apparatus and method are capable of detecting targets in a short time efficiently by detecting fluorescent particles that produce fluorescence upon exposure to light, such as fine particles of various targets (for example, proteins and antigens) labeled with a fluorescent label and of capturers labeled with a fluorescent label (for example, antibodies) capable of combining with the targets.

The target detecting apparatus of the present invention is capable of detecting targets in a short time efficiently, by detecting fluorescent particles that produce fluorescence upon exposure to light, such as fine particles of various targets (for example, proteins and antigens) labeled with a fluorescent label and of capturers labeled with a fluorescent label (for example, antibodies) capable of combining with the targets.

The target detecting apparatus of the present invention may be used appropriately in a wide range of fields including medical sciences, biology, etc., and may be applied further in medical diagnosis.

The target detecting method of the present invention is capable of detecting the targets in a short time and efficiently, by detecting fluorescent particles formed from a protein, etc. labeled with a fluorescent label, and can be applied appropriately in a wide range of fields including medical science and biology, etc.

What is claimed is:

1. A target detecting apparatus comprising:
a first container having a metal inside and containing a fluorescent particle which generates fluorescence on exposure to light and quenches the fluorescence on contacting the metal;
a second container having the metal inside and containing a target sample that contains at least the fluorescent particle therein;
a centrifugal force giving unit configured to allow the fluorescent particles to be in contact with the metal by giving a centrifugal force to the first container and the second container;
a light irradiation unit configured to expose the fluorescent particle contained in each of the first container and the second container to light; and
a fluorescence detecting unit configured to detect an intensity of fluorescence generated by the fluorescent particle upon exposure to light from the light irradiation unit.

2. The target detecting apparatus according to claim 1, wherein the metal in the first container and the second container is a gold film formed on at least any one of a inner bottom and an inner side surface the container.

3. The target detecting apparatus according to claim 1, wherein the fluorescent particle is at least one selected from a fluorescent label, a target labeled with the fluorescent label, a target capturer which is capable of capturing the target and which is labeled with the fluorescent label, and a particle of a complex of the target and the target capturer, the particle being labeled with the fluorescent label.

4. The target detecting apparatus according to claim 3, wherein the target is an antigen and the target capturer is an antibody.

5. The target detecting apparatus according to claim 3, wherein the fluorescence peak wavelength of the fluorescent label is from 500 nm to 900 nm.

6. The target detecting apparatus according to claim 5, wherein the fluorescent label is at least one selected from Cy3 and rare earth element fluorescent complexes.

7. The target detecting apparatus according to claim 3, wherein the particle forming the fluorescent particle and to be labeled with the fluorescent label is one of the target and the target capturer that is the smaller with respect to at least one of particle diameter and mass.

8. The target detecting apparatus according to claim 1, wherein the fluorescence detecting unit detects intensity of fluorescence against any one of sedimentation time of the fluorescent particle and the number of revolutions of the centrifugal force giving unit, the fluorescence generated by the fluorescent particle that has been given a centrifugal force by the centrifugal force giving unit.

9. The target detecting apparatus according to claim 6, wherein
the fluorescent label is at least one selected from rare earth element fluorescent complexes,
the fluorescent particle is a delayed fluorescence particle which generates fluorescence upon exposure to light and maintains the fluorescence for a predetermined time after the light is quenched,
the delayed fluorescence particle is exposed to light from the light irradiation unit at predetermined time intervals, and
the fluorescence detecting unit is so controlled by a detection controlling unit that intensity of fluorescence generated by the delayed fluorescence particle is detected after a predetermined time from the finish of exposure to the light.

10. The target detecting apparatus according to claim 9, wherein the detection controlling unit controls the fluorescence detecting unit to detect the intensity of fluorescence 0.1 milliseconds or more after the finish of exposure to light from the light irradiation unit.

11. The target detecting apparatus according to claim 1, wherein the light irradiation unit and the fluorescence detecting unit are fixed to the target detecting apparatus, and only the first container and the second container are revolved by the centrifugal force giving unit.

12. The target detecting apparatus according to claim 1, wherein the centrifugal force giving unit has a plurality of the second containers which are placed along the rotation circumference of the centrifugation.

13. The target detecting apparatus according to claim 1, wherein the particular second container is exposed to light from the light irradiation unit, and intensity of fluorescence generated by the fluorescent particle in the second container is continuously detected by the fluorescence detecting unit.

14. The target detecting apparatus according to claim 13, wherein the fluorescence detecting unit revolves with any one of the first container and the second container, and transmits a fluorescence intensity signal wirelessly to a fluorescence intensity receiver.

15. The target detecting apparatus according to claim 1, wherein the fluorescence detecting unit is at least any one of a photomultiplier tube, an avalanche photodiode, and a CCD camera.

16. A target detecting method comprising:
giving a centrifugal force to a first container having a metal inside and containing a fluorescent particle which generates fluorescence upon exposure to light and quenches the fluorescence upon contacting with the metal, and to a second container having the metal inside and containing a target sample containing at least the fluorescent particle therein, to thereby contact the fluorescent particle to the metal,
exposing the fluorescent particle contained in each of the first container and the second container to light; and
detecting an intensity of fluorescence generated by the fluorescent particle upon exposure to light.

17. The target detecting method according to claim 16, wherein the metal in the first container and the second container is a gold film formed on at least any one of an inner bottom and an inner side surface of the container.

18. The target detecting method according to claim 16 wherein the fluorescent particle is at least one selected from a fluorescent label, a target labeled with the fluorescent label, a target capturer which is capable of capturing the target and which is labeled with the fluorescent label, and a particle of a complex of the target and the target capturer, the particle being labeled with the fluorescent label.

19. The target detecting method according to claim 16, further comprising evaluating the difference in the intensity change of fluorescence between the fluorescent particle in the first container and the fluorescent particle in the second container.

20. The target detecting method according to claim 19, wherein
the fluorescent particle in the first container is a target capturer labeled with a fluorescent label, the target sample in the second container comprises a fluorescent particle formed from a target and the target capturer labeled with the fluorescent label, and
the fluorescence intensity evaluating step evaluates the difference in intensity change of fluorescence between the fluorescent particle between in the first container and the fluorescent particle in the second container, to thereby determine the formation of the complex of the target and the target capturer.
